(19) United States
(12) Patent Application Publication
(10) Pub. No.: US 2016/0036710 A1
(43) Pub. Date: Feb. 4, 2016

(54) NETWORK SYSTEM, TRAFFIC MANAGEMENT SERVER, AND BASE STATION MANAGEMENT SERVER

(71) Applicant: Hitachi, Ltd., Tokyo (JP)

(72) Inventors: Seishi HANAOKA, Tokyo (JP); Yusuke SHOMURA, Tokyo (JP); Rintaro KATAYAMA, Tokyo (JP); Yasuhito MAEJIMA, Tokyo (JP)

(21) Appl. No.: 14/725,588

(22) Filed: May 29, 2015

(30) Foreign Application Priority Data
Aug. 1, 2014 (JP) 2014-157307

(51) Int. Cl. H04L 12/855; H04W 72/10; H04L 12/851

(52) U.S. Cl. CPC H04L 47/2466; H04L 47/24; H04W 72/10; H04W 88/08

(57) ABSTRACT

In a traffic management server, base station control corresponding to application information is instructed and it is instructed to control traffic, with respect to a specific application of a specific user, on a core network-side in cooperation with information related to a radio area calculated in a base station management server, whereby quality of experience (QoE) in a mobile terminal of a subscriber is improved.

### CROSS-REFERENCE TO RELATED APPLICATIONS

This application claims the priority of Japanese Patent Application No. 2014-157307, filed on Aug. 1, 2014, which is incorporated herein by reference in its entirety.

### BACKGROUND OF THE INVENTION

1. Field of the Invention

An embodiment of the present invention relates to traffic analysis and a traffic control technique in a communication network.

2. Description of the Related Art

A mobile phone communication network (hereinafter, referred to as mobile network) of a mobile phone company (hereinafter, referred to as mobile company) includes a plurality of network nodes. Then, a mobile terminal of a mobile phone service subscriber (hereinafter, referred to as subscriber) transmits/receives packet data to/from an external network such as the Internet through the plurality of network nodes.

### SUMMARY OF THE INVENTION

In order to keep quality of experience (QoE) of packet data communication for a subscriber, it is necessary to control traffic when necessary in addition to estimation of a place of traffic congestion in a mobile network. There are mainly two methods to control traffic. One is a method to change a system parameter in a base station in view of quality improvement in a radio section. The other is a method to control priority of traffic in a subscriber unit based on a charging system or quality of service (QoS) setting through a policy control server provided on a core network-side.

However, in a base station, it is not possible to identify an application used by an individual mobile terminal. By uniformly changing a system parameter of the base station regardless of a characteristic or a difference of the application, radio quality (such as received radio signal strength) between the base station and the mobile terminal is improved.

In this case, for example, even when an application of a mobile terminal at a service area boundary of the base station is a very-low-speed application which scarcely uses a band, a directivity of an antenna is adjusted to a direction of the mobile terminal or a system parameter is changed in order to make it possible for the mobile terminal at the boundary to download a file comfortably. Thus, it has been difficult to perform area optimization in consideration of an application and to improve quality of experience (QoE) in a mobile terminal using an application which requires more bands in the same service area.

In addition, in a policy control server (PCRF: policy and charging rules function) on the core network-side, priority of traffic of each subscriber is controlled not by dynamic control in which a state of a radio section is recognized but by policy control corresponding to a form of a contract or the like of the subscriber.

In this case, for example, even when a radio wave state of the mobile terminal at the service area boundary of the base station is bad and an effect of performing the priority control (such as assignment of more band compared to different mobile terminal) is not expected, control is performed based on a form of a contract or a policy. Thus, it has been difficult to perform area optimization in consideration of a radio state, that is, to perform more effective band assignment according to a radio state in the same service area. Thus, it has been difficult to improve quality of experience (QoE) of the user.

Also, in JP-2012-70067-A, it is disclosed that detection of performance deterioration of an application in a base station and factor analysis thereof are performed and that a result thereof is displayed. However, area optimization in consideration of an application or a radio state is not described.

Thus, an embodiment of the present invention is provided with respect to core network-side traffic control which is based on base station control in view of improvement of radio quality, a policy in a form of a contract, or the like in order to improve quality of experience (QoE) in mobile terminals of more subscribers in more areas.

Outlines of embodiments of the invention disclosed in the present application will be described briefly in the following. That is, an embodiment is a network system including: a plurality of terminal devices; a plurality of base stations configured to house the plurality of terminal devices; a base station management server configured to manage the plurality of base stations; a core network-side device connected to the plurality of base stations; an analysis device configured to acquire a packet between the plurality of base stations and the core network-side device; and a traffic management server connected to the analysis device. In the network system, the base station management server and the traffic management server are connected to each other, the base station management server performs control of the base stations, the core network-side device performs traffic control of a specific terminal device, and the traffic management server acquires information of an application used by the terminal device based on the packet and performs, based on the information of the application, at least one of control of the base stations and traffic control of the specific terminal device.

Also, an embodiment is a traffic management server in a network system including a plurality of terminal devices, a plurality of base stations configured to house the plurality of terminal devices, abase station management server configured to manage the plurality of base stations, a core network-side device connected to the plurality of base stations, an analysis device configured to acquire a packet between the plurality of base stations and the core network-side device, and a traffic management server connected to the analysis device. The traffic management server is connected to the base station management server configured to control the base stations, acquires, based on the packet, information of an application used by the terminal devices, and gives, based on the information of the application, at least one of an instruction to the base station management server to perform control of the base stations and an instruction to the core network-side device to perform traffic control of a specific terminal device.

Also, an embodiment is a network system including: a plurality of terminal devices; a plurality of base stations configured to house the plurality of terminal devices; a base station management server configured to manage the plurality of base stations; a core network-side device connected to the plurality of base stations; an analysis device configured to acquire a packet between the plurality of base stations and the core network-side device; and a traffic management server connected to the analysis device. In the network system, the base station management server collects information of a service area of each of the base stations and transmits the collected information to the traffic management server, and the traffic management server acquires, based on the packet, information of an application used by the terminal devices and quality information of the terminal devices, calculates a quality of experience (QoE) index of each application used by the terminal devices based on the quality information of the terminal devices, and calculates and displays a service area of the application in each base station and each application based on the information of the service area, the number of terminal devices quality of experience (QoE) indexes of which exceed a predetermined value, and the number of terminal devices using the application.

Also, an embodiment is a base station management server in a network system including a plurality of terminal devices, a plurality of base stations configured to house the plurality of terminal devices, a base station management server configured to manage the plurality of base stations, a core network-side device connected to the plurality of base stations, an analysis device configured to acquire a packet between the plurality of base stations and the core network-side device, and a traffic management server connected to the analysis device. The base station management server is connected to the traffic management server and performs control of the base stations when receiving an instruction from the traffic management server based on information of an application used by the terminal devices which information is acquired based on the packet.

According to an embodiment of the present invention, it is possible to improve quality of experience (QoE) in a mobile terminal of a subscriber.

A problem, configuration, and effect other than what has been described above will be disclosed in a description of the following embodiments.

### BRIEF DESCRIPTION OF THE DRAWINGS

FIG. 1 is a view illustrating a system configuration example according to a present embodiment;

FIG. 2 is a view illustrating a different system configuration example according to the present embodiment;

FIG. 3 is an example of a user information table in a first embodiment;

FIG. 4 is an example of an application distribution information table in the first embodiment;

FIG. 5 is an example of a control method management table in a third embodiment;

FIG. 6 is a view illustrating an operation concept of the first embodiment;

FIG. 7 is a view illustrating a configuration example of a base station management server in the first embodiment;

FIG. 8 is a view illustrating a configuration example of a traffic management server in the first embodiment;

FIG. 9 is a flowchart illustrating an example of a processing flow of an application distribution update program in the first embodiment;

FIG. 10 is a flowchart illustrating an example of a processing flow of a RAN control determination program in the first embodiment;

FIG. 11 is a view illustrating an example of a processing sequence in the first embodiment;

FIG. 12 is a view illustrating an example of an interface between a base station management server and a traffic management server in the first embodiment and the third embodiment;

FIG. 13 is a graph of an operation concept of a second embodiment;

FIG. 14 is a view illustrating a configuration example of a base station management server in the second embodiment;

FIG. 15 is a view illustrating a configuration example of a traffic management server in the second embodiment;

FIG. 16 is a flowchart illustrating an example of a processing flow of a band limitation instruction processing program in the second embodiment;

FIG. 17 is a view illustrating an example of a processing sequence in the second embodiment;

FIG. 18 is a view illustrating an example of an interface between a base station management server and a traffic management server in the second embodiment;

FIG. 19 is a graph of an operation concept of the third embodiment;

FIG. 20 is a view illustrating a configuration example of a base station management server in the third embodiment;

FIG. 21 is a view illustrating a configuration example of a traffic management server in the third embodiment;

FIG. 22 is a flowchart illustrating an example of a processing sequence in the third embodiment;

FIG. 23 is a view illustrating an operation concept of a fourth embodiment;

FIG. 24 is a view illustrating a configuration example of a base station management server in the fourth embodiment;

FIG. 25 is a view illustrating a configuration example of a traffic management server in the fourth embodiment;

FIG. 26 is a flowchart illustrating an example of a processing flow of an application coverage calculation program in the fourth embodiment;

FIG. 27 is a view illustrating an example of an interface between a base station management server and a traffic management server in the fourth embodiment;

FIG. 28 is a graph of an operation concept of a fifth embodiment;

FIG. 29 is a view illustrating a configuration example of a base station management server in the fifth embodiment;

FIG. 30 is a view illustrating a configuration example of a traffic management server in the fifth embodiment;

FIG. 31 is a flowchart illustrating an example of a processing flow of a RAN control and band limitation determination program in the fifth embodiment;

FIG. 32 is an example of a RAN control index table in the first embodiment;

FIG. 33 is an example of abase station information table in the fourth embodiment;

FIG. 34 is an example of a user information table in the fourth embodiment; and

FIG. 35 is an example of a RAN control index table in the fifth embodiment.

### DESCRIPTION OF THE PREFERRED EMBODIMENTS

### First Embodiment

In the following, an embodiment of the present invention will be described with reference to the drawings.

Note that in the following embodiment, a description will be made by dividing the embodiment into a plurality of sections or embodiments when necessary for convenience. However, except for a specifically-defined case, the plurality of sections or embodiments is foreign to each other. For example, one is a modification, a detail, or a supplemental description of a part or whole of the other.

Also, in the following embodiment, in a case of referring to the number of elements or the like (including number of pieces, numeric value, amount, range, and the like), the number of elements or the like is not limited to a specific number and may be more or less than the specific number except for a case where definition is made specifically and a case where limitation to the specific number is obvious in principle.

In addition, in the following embodiment, a component (including element step or the like) is not always necessary except for a case where definition is made specifically or a case where necessity is obvious in principle.

Moreover, an embodiment described in the following may be applied independently or a plurality of embodiments or all embodiments may be combined and applied.

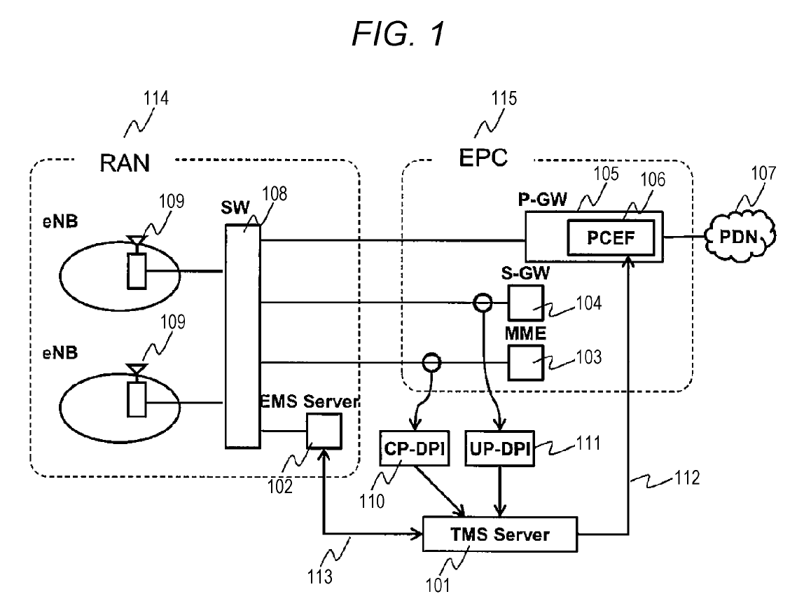

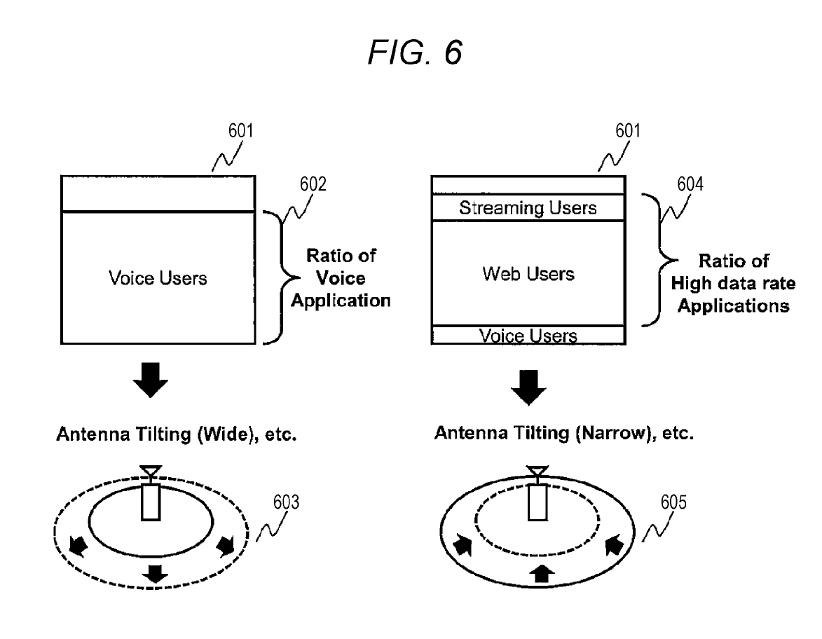

A system configuration and an operation concept of the present embodiment will be described with reference to FIG. 1 and FIG. 6.

In the present embodiment, for example, when it is recognized that most of mobile terminals of subscribers which terminals are connected to a base station are mobile terminals of subscribers during voice communication, an area is expanded instead of a band of a channel assigned to each mobile terminal. Here, based on an application distribution characteristic, an antenna directivity or a system parameter of the base station is changed to perform area optimization.

As illustrated in FIG. 1, the present system includes a traffic management server 101 (hereinafter, referred to as TMS server), packet detail analysis devices 110 and 111 (hereinafter, referred to as DPI), a mobile core network 115 (hereinafter, referred to as EPC), a radio access network 114 (hereinafter, referred to as RAN) to house a mobile terminal, a packet data network 107 (hereinafter, referred to as PDN), and a base station management server 102 (hereinafter, referred to as EMS server) to manage abase station 109 to house a plurality of terminal devices. Also, the mobile core network is connected to the plurality of base stations 109 through a switch 108 and includes a mobility management entity (MME) 103, a serving gateway (S-GW) 104, and a packet data network gateway (P-GW) 105. The MME 103 is a communication device which houses one or more base stations 109 and provides mobility control. The MME 103 manages a bearer between a mobile phone terminal and the P-GW 105. In attaching and a handover of a mobile phone terminal, the MME 103 selects the S-GW 104 for the terminal. The S-GW 104 is a gateway which houses one or more base stations 109 and transmits user data between the P-GW 105 and the base stations 109. The P-GW 105 is a gateway including an interface with the PDN 107. The P-GW 105 assigns an IP address to a mobile terminal. Also, the P-GW 105 includes a policy and charging enforcement function (PCEF) 106. Based on an instruction from the TMS server, the PCEF 106 performs policy control and performs traffic control or the like of a specific terminal device.

The DPI is an analysis device to analyze a packet on a network. The CP-DPI 110 (C-plane DPI) monitors an S1 interface (S1-MME) to connect the base station 109 and the MME 103. The UP-DPI 111 (U-plane DPI) monitors an S1 interface (S1-U) to connect the base station 109 and the S-GW 104. Then, the CP-DPI 110 and the UP-DPI 111 transfers, to the TMS server 101, various messages or statistical information acquired through the I/F.

Note that in the present embodiment, as a unit with which the TMS server 101 monitors a system behavior in a mobile network, a configuration in which the DPI monitors the S1 interface is described as an example. With the configuration, the mobile company can reduce the number of monitoring points compared to a case where the DPI monitors all base stations on a RAN-side, whereby it is possible to control a facility cost and an operational cost necessary for a monitoring operation.

Then, the TMS server 101 specifies a type of an application used by each mobile terminal based on the various messages or statistical information received from the DPIs 110 and 111, counts the type in each base station 109, and calculates an application distribution in each base station 109.

Next, control necessary for area optimization is determined based on the calculated application distribution and it is instructed, through an interface 113 with the EMS server 102, to the EMS server 102 to perform setting change of a tilt angle of an antenna or a different system parameter in the base station 109.

Here, a relationship between application distribution and control for area optimization will be described with reference to FIG. 6. Various kinds of statistical information are collected by using the DPI. In the TMS server 101, with respect to each base station 109, the numbers of users of each application is calculated among the total numbers of sessions 601 of all applications of all mobile terminals connected to the base station 109 and calculates distribution thereof. Here, 602 indicates a state in which the most of all connected mobile terminals uses an application for voice communication. Also, 604 indicates a state in which the most of all connected mobile terminals is users performing streaming reception at high communication speed or users using an application of rich content such as web browsing.

In a state such as 602, a percentage of mobile terminals which require high-speed communication is low. Thus, communication at low speed is enough in most of parts of an area. In order to improve quality of experience (QoE) in a mobile terminal in voice communication, an instruction to perform control to reduce the number of handovers between base stations along with movement of the mobile terminal and to secure stable communication quality is given. As indicated in 603, in an example of the control, an instruction is given to perform control to change a tilt angle of an antenna of the base station 109 slightly in a horizontal direction from a current angle and to expand an area of the base station 109.

On the other hand, in a state such as 604, a percentage of mobile terminals which require high-speed communication is high. Thus, an instruction is given to perform control to improve radio communication quality specifically in an area which is near a boundary of the base station and which has the lowest received radio signal strength. As an example of the control, there is, for example, a method to increase transmission power in the base station 109 and to increase reception power of a mobile terminal or a method of giving an instruction to perform control to change a tilt angle of an antenna slightly in a vertical direction from a current angle as indicated in 605, reducing an area of the base station 109, and increasing reception power of a mobile terminal near a boundary of the base station 109.

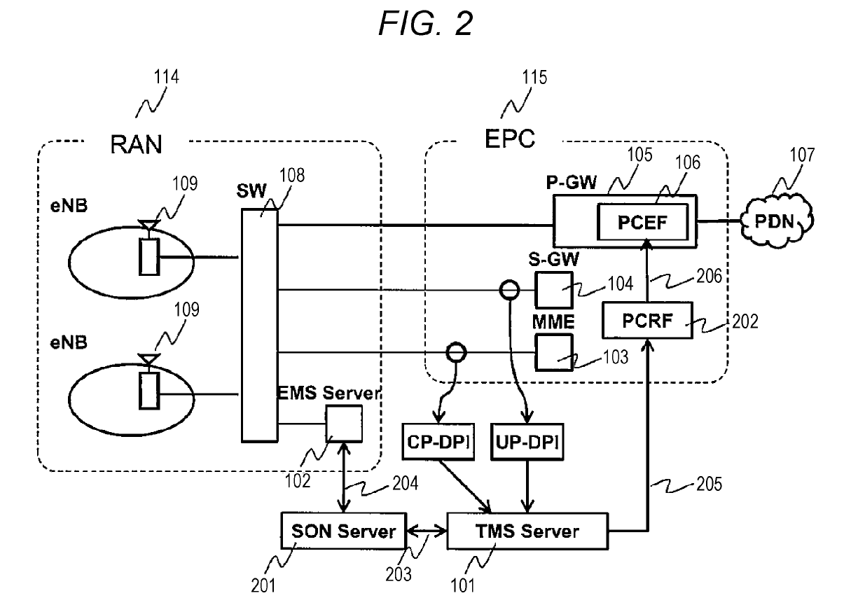

FIG. 2 is a view illustrating an example in which the TMS server gives an instruction to the EMS server 102 through a SON server 201 instead of giving an instruction directly to the EMS server 102 when giving the instruction to the base station 109 to change an antenna tilt angle or a different system parameter of a different base station 109. The SON server is connected to a plurality of EMS servers 102. The SON server gives each of the plurality of EMS servers 102 an instruction of a control policy for control of a base station or arbitrates control between a plurality of base stations connected to different EMS servers. Also, an example of giving an instruction of policy control to the PCEF 106 through a PCRF 202 instead of directly giving the instruction of policy control from TMS server 101 to the PCEF 106 through an interface 112 is illustrated. In this case, interfaces 203 and 205 through which the TMS server 101 gives a control instruction are newly provided. As an interface 204 between the SON server 201 and the EMS server 102 or an interface 206 between the PCRF 202 and the PCEF 106, an existing interface in a mobile network can be used.

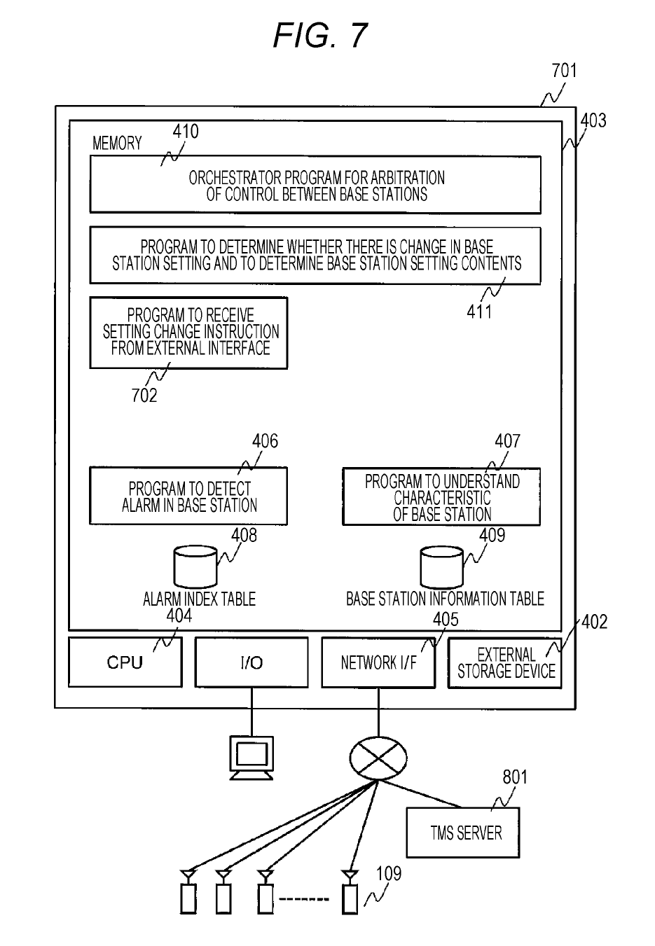

In FIG. 7, a configuration example of an EMS server 701 of the present embodiment is illustrated. A function of the EMS server 701 in the present embodiment is stored in a form of program software in an external storage device 402 of a general computer. The function of the EMS server 701 is expanded in a memory 403 and is executed by a CPU 404. Also, the EMS server 701 communicates with each base station 109 through a network I/F 405. The memory 403 of the EMS server 701 stores a program 406 to detect an alarm in a base station, a program 407 to understand a characteristic of a base station, a program 411 to determine whether there is a change in base station setting and to determine base station setting contents, and an orchestrator program 410 to perform arbitration during control between a plurality of base stations. Moreover, the memory 403 of the EMS server 701 stores an alarm index table 408 to store a detection threshold or the like of an alarm in the base station 109 and a base station information table 409 to store an operation state of each base station 109. Moreover, the EMS server 701 is connected to a TMS server 801 through the network I/F 405 and includes a program 702 to receive a setting change instruction of a system parameter of the base station 109 through the interface 405.

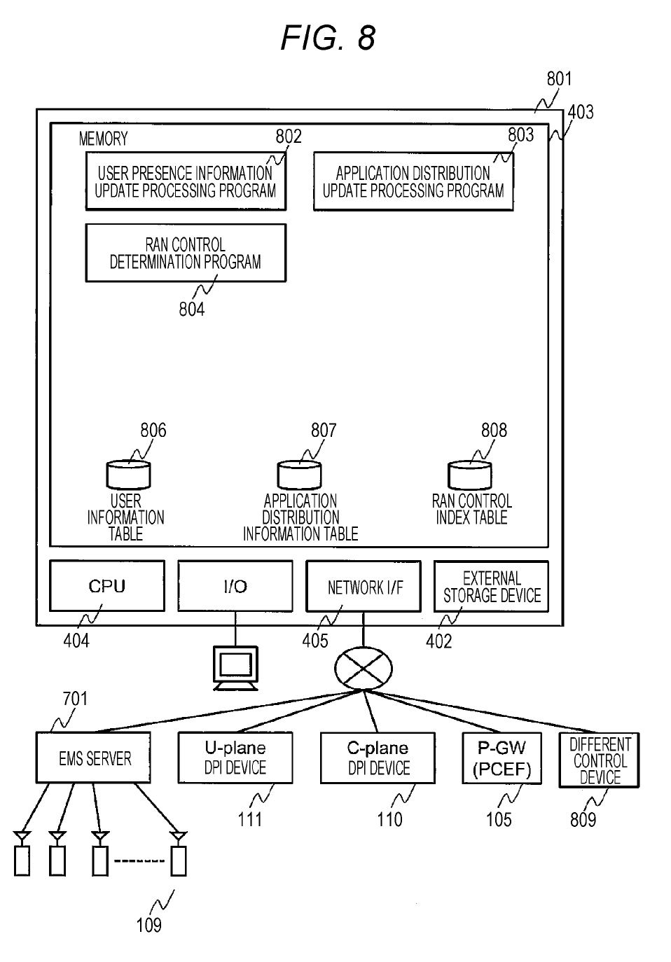

In FIG. 8, a configuration example of the TMS server 801 of the present embodiment is illustrated. A function of the TMS server 801 of the present embodiment is stored in a form of program software in the external storage device 402 of a general computer. The function of the EMS server 801 is expanded in the memory 403 and is executed by the CPU 404. Also, the TMS server 801 communicates with the EMS server 701, the DPIs 110 and 111, and the P-GW 105 through the network I/F 405. A communication function with respect to a different control device 809 such as the PCRF 202 may be included. The memory 403 of the TMS server 801 stores a user presence information update processing program 802, an application distribution update processing program 803, and a RAN control determination program 804. Also, the memory of the TMS server 801 stores a user information table 806 to manage an IP address, a connection destination, and an in-use application of each user while associating these to each other, an application distribution information table 807 to hold application distribution in each base station 109, and a RAN control index table 808 to be an index of RAN control.

Note that in the present embodiment, a configuration in which the program and the information are stored into a memory of a single computer has been described. However, it is possible to include a configuration in which the information is stored into an external storage device, the information is read from the external storage device at each time processing of the program is performed, and storage into the external storage device is performed at each time the processing is over.

Also, it is possible to store the program and the information into a plurality of computers separately. For example, pieces of the information can be implemented as tables in a relational database and stored into a database server different from the TMS server 801. Then, the program executed in the TMS server 801 can refers to or updates the information in the database server.

Also, the information can be stored into a distributed key-value store server different from the TMS server 801 and the program executed in the TMS server 801 can refers to and updates the information in the key-value store server.

The above-described difference in a storage method of the information has no influence on the essence of an embodiment of the present invention.

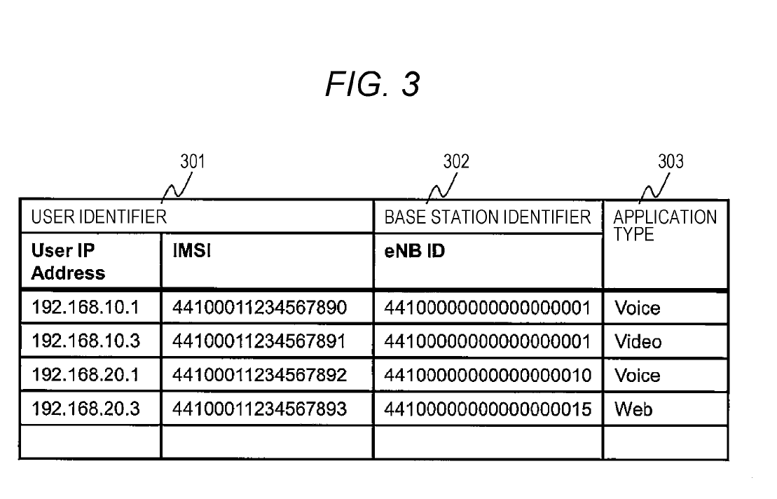

FIG. 3 is an example of the user information table 806 held by the TMS server 801. The TMS server stores user information of each user, which information is acquired from the DPIs 110 and 111, into the user information table 806. The user information includes a user identifier 301, a base station identifier 302, and an application type 303. The user identifier 301 is used to identify a user uniquely. The user information table 806 stores, as the user identifier 301, at least one kind of identifier. In the example in FIG. 3, a user IP address and international mobile subscriber identity (IMSI) are employed as the user identifier 301. The base station identifier 302 is used to uniquely identify a base station where a user is present. In the example in FIG. 3, an eNB ID is employed as the base station identifier 302. The application type 303 is a type of an application used by a user. When a user uses a plurality of applications simultaneously, a plurality of items is stored into the application type 303 or a plurality of lines is created for one user. The user identifier 301, the base station identifier 302, and the application type 303 are directly acquired from the DPI 110 and the DPI 111 and stored in a form of the user information table illustrated in FIG. 3, the base station identifier 302 and the application type 303 being associated with the user identifier. The user presence information update processing program 802 updates information in the table 806 periodically at timing of an output from the DPI 110 and the DPI 111 or according to an event such as a change of a present base station to which a user is connected or a change of a used application.

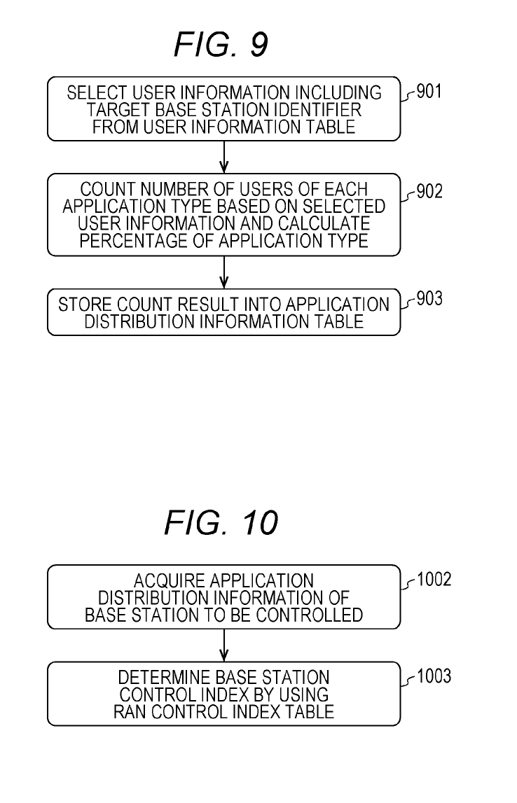

In FIG. 9, an example of a detail processing flow of the application distribution update processing program 803 executed by the TMS server 801 is illustrated. The TMS server 801 performs the application distribution update processing program 803 with respect to each base station 109. The TMS server 801 performs the application distribution update processing program 803, for example, in a predetermined time cycle. In step 901, the TMS server 801 selects, from the user information table 806, user information including a base station identifier 302 of a target base station 109. Then, in step 902, the TMS server 801 counts the number of users of each application type based on the user information selected in step 901 and calculates a percentage of users of each application type. In step 903, the TMS server 801 stores, into the application distribution information table 807, a percentage of users of each application type in a base station identifier A which percentage is acquired in step 902.

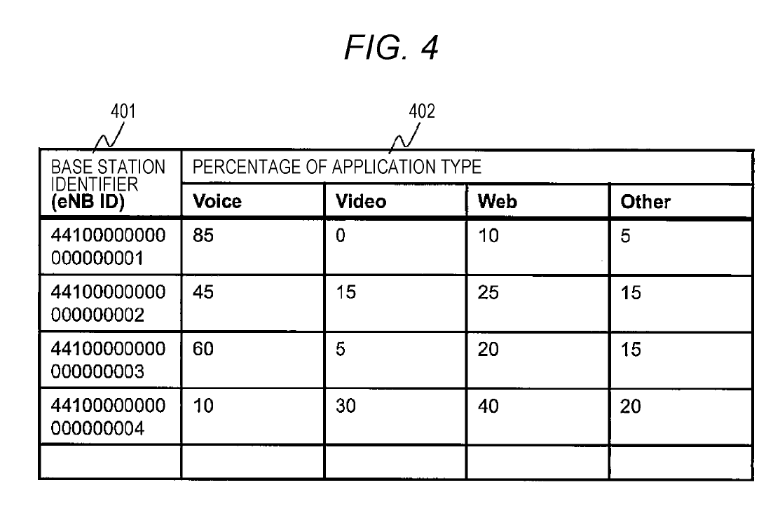

FIG. 4 is an example of the application distribution information table 807 held by the TMS server 801. The application distribution information table 807 holds application distribution information of each base station. The application distribution information includes a base station identifier 401 and a percentage of users 402 of each application type.

In FIG. 10, an example of a detail processing flow of the RAN control determination program 804 executed by the TMS server 801 is illustrated. The TMS server 801 performs the RAN control determination program 804 with respect to each base station 109. For example, the TMS server 801 may perform the application distribution update processing program 803 in a certain time cycle or may perform the program when the application distribution update processing program 803 is completed. In step 1002, the TMS server 801 acquires, from the application distribution information table 807, application distribution information of the corresponding base station. Next, in step 1003, the TMS server 801 checks the application distribution information acquired in step 1002 in the RAN control index table and determines a control policy of the base station.

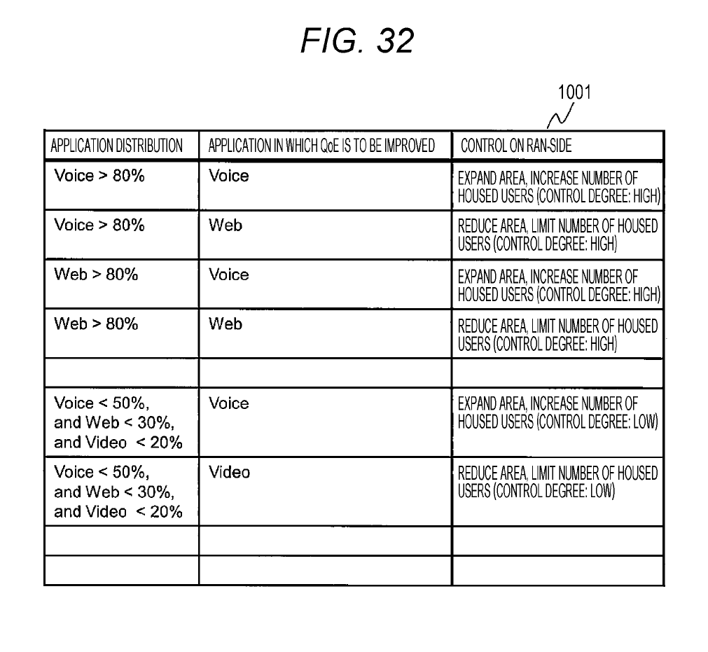

An example of the RAN control index table is illustrated in 1001 in FIG. 32.

Here, calculated application distribution (left column in table), a column to designate a type of an application (center column in table) in which quality of experience (QoE) is intended to be kept or improved, and a column (right column in table) in which an example of a detail control performed on the RAN-side based on the two pieces of information are associated to each other. The RAN control index table 1001 is set, for example, by a maintainer. A type of an application in which quality of experience (QoE) is intended to be kept or improved is set separately by the maintainer for each system or each base station. In an example of 1001, a brief control policy such as expanding an area or increasing the number of housed users is described as the control on the RAN. Here, for example, as control based on the policy to expand an area or to increase the number of housed users, an antenna tilt angle of the base station is increased, transmission power of the base station is increased, or user connection limitation is released in the base station. As control based on a policy to reduce an area or to limit the number of housed users, for example, an antenna tilt angle of the base station is decreased, transmission power of the base station is decreased, or user connection limitation is tightened in the base station. Also, in 1001, a degree of control in the control with respect to the RAN is described. This indicates, for example, an amount of changing a tilt angle in increasing/decreasing an antenna tilt angle in the base station, an amount of changing transmission power in increasing/decreasing the transmission power in the base station, or an amount of changing a limitation rate in a case of tightening or relaxing user connection limitation in the base station.

In FIG. 4, a detail example of RAN control determination in step 1003 will be described with a base station having an eNB ID=44100000000000000001 as an example. When application distribution information in FIG. 4 is checked in the RAN control index table 1001, the base station having an eNB ID=44100000000000000001 corresponds to application distribution Voice>80%. For example, as a method to select an application in which quality of experience (QoE) is intended to be kept or improved, a method to perform determination uniquely based on an operation policy of an operating communication company or a method to select, as an application to be improved, an application which is used the most in the area is considered. When a type of an application in which quality of experience (QoE) is to be kept or improved is Voice, the control on the RAN-side is determined as “expanding an area and increasing the number of housed users (control degree: high)” from the RAN control index table 1001. On the other hand, when a type of an application in which quality of experience (QoE) is to be kept or improved is Web, the control on the RAN-side is determined as “reducing an area and decreasing the number of housed users (control degree: high)” from the RAN control index table 1001.

Note that when there is no correspondence as a result of checking the application distribution information in the RAN control index table 1001, it is determined that control on the RAN-side is not performed.

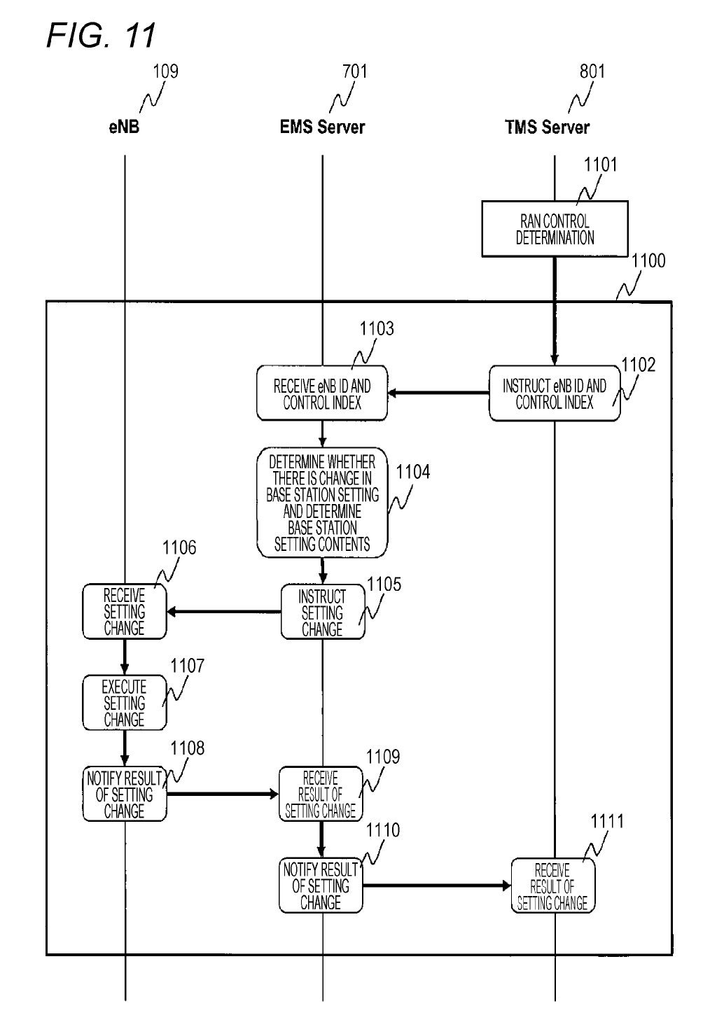

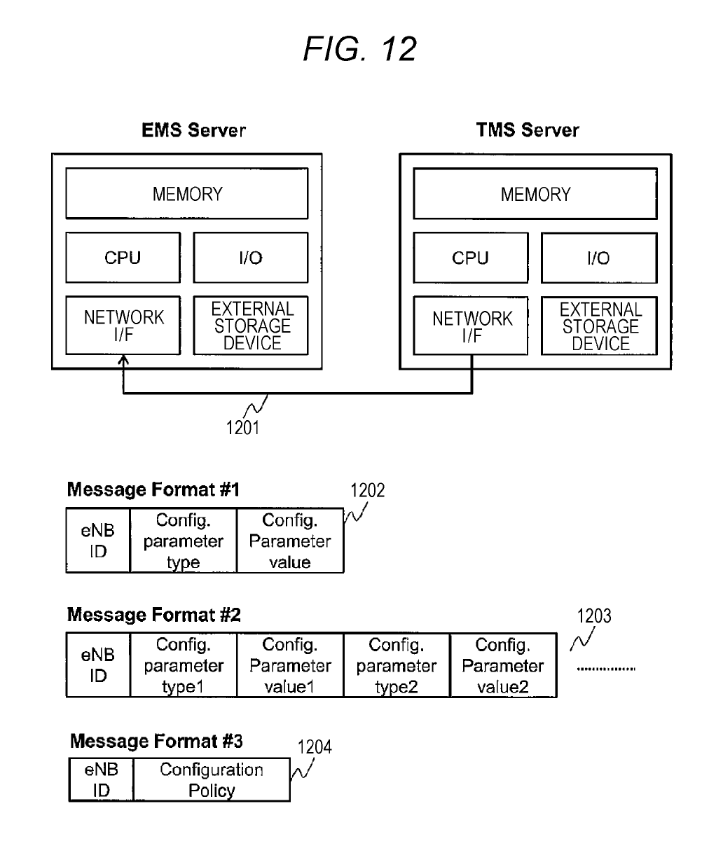

In FIG. 11, a series of processing sequence performed between the EMS server 701 and the TMS server 801 is illustrated. A sequence 1101 is RAN control determination processing performed in the RAN control determination program 804. When it is determined that control on the RAN-side is to be performed as a result of the RAN control determination processing in the sequence 1101, the TMS server 801 notifies, in a sequence 1102, an identifier (eNB ID) of the base station 109 to be controlled and a control policy or control contents to the EMS server 701. The EMS server 701 receives, in a sequence 1103, the identifier (eNB ID) of the base station 109 to be controlled and a control policy or control contents. The EMS server 701 determines whether there is a change in base station setting, determines base station setting contents (sequence 1104), and gives an instruction of setting change to the base station 109 (sequence 1105). The base station 109 receives an instruction of setting change in a sequence 1106. Based on the received setting change contents, the base station 109 executes the setting change in the base station 109 (sequence 1107) and notifies a result of the execution to the EMS server 701 (sequence 1108). The EMS server 701 receives, in a sequence 1109, the result of the execution of the setting change in the base station 109. The EMS server 701 notifies the result of the execution of the setting change in the base station 109 to the TMS server 801 (sequence 1110). The TMS server 801 receives, in a sequence 1111, the result of the execution of the setting change in the base station 109.

Note that a series of sequences from the sequence 1102 to the sequence 1111 is referred to as a base station control sequence 1100. The base station control sequence 1100 is executed with the eNB ID and the control policy or the control contents being input.

In FIG. 12, a detail example of a message communicated between the EMS server 701 and the TMS server 801 is illustrated. In the present embodiment, as illustrated in 1201, a message is transmitted from the TMS server 801 to the EMS server 701. Note that there may be a message from the EMS server 701 to the TMS server 801 such as a response to the message transmitted from the TMS server 801 to the EMS server 701. When a system parameter of the base station 109 is set in detail by the TMS server 801, a set of an ID of the base station 109, a kind of a parameter, and a value set as the parameter is transmitted as a format of the message transmitted at this time, as indicated in 1202. When it is determined that it is necessary to instruct one base station 109 to change a plurality of system parameters, a plurality of parameter changes may be transmitted juncturally as indicated in 1203. On the other hand, when setting of detail system parameter of the base station 109 is not performed by the TMS server 801 and only a control policy is instructed therefrom and in a case where detail system parameter setting is determined in the EMS server 701, an ID of the base station 109 and a control policy are transmitted in such a manner indicated in 1204.

### Second Embodiment

In the present embodiment, information of various alarms detected in an EMS server 1401 is notified to a TMS server 1501 with the various alarms as triggers. In the TMS server 1501, traffic control is performed with respect to a specific user in a specific base station in order to reduce the alarms.

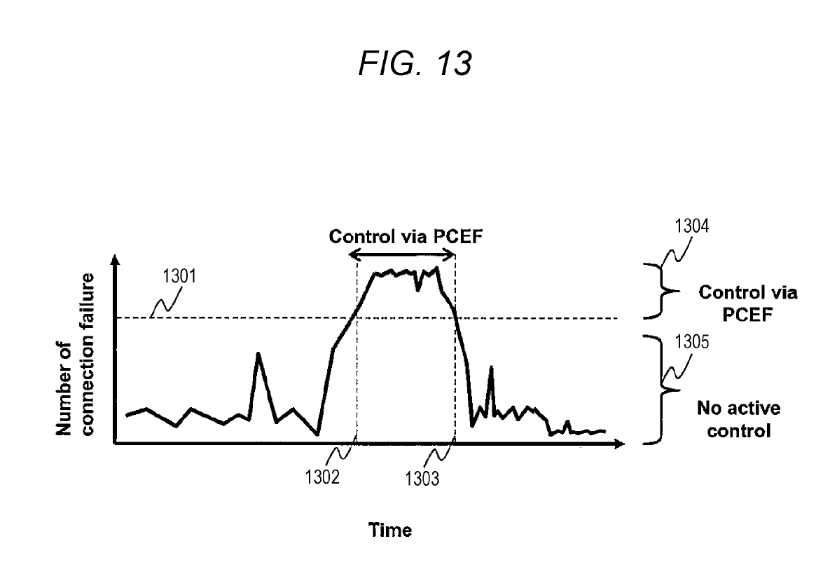

In FIG. 13, an example of an operation concept in the present embodiment is illustrated. Here, a case where the number of times of connection failure is focused as one piece of statistical information which is directly measured by the EMS server or measured through a connected base station and where an alarm triggered by exceeding of a threshold of the number of times of connection failure is detected will be described as an example. FIG. 13 is a time-series graph of the number of times of connection failure acquired by a base station 109. A threshold of alarm transmission is indicated in 1301. The alarm threshold 1301 is previously set by an administrator. When the number of times of connection failure in the base station 109 exceeds the alarm threshold 1301 (1302), the EMS server 1401 transmits alarm information to the TMS server 1501. When the TMS server 1501 determines that the connection failure is caused due to resource shortage, a PCEF 106 is instructed to control traffic flowing in the corresponding base station 109. After the control is applied to the PCEF 106, the TMS server 1501 monitors an alarm state of the number of times of connection failure. When it is checked that the number of times of connection failure is lower than the alarm threshold (1303), the traffic control in the PCEF 106 is released.

In such a manner, traffic is controlled based on the information acquired from the EMS server 1401 to improve communication quality.

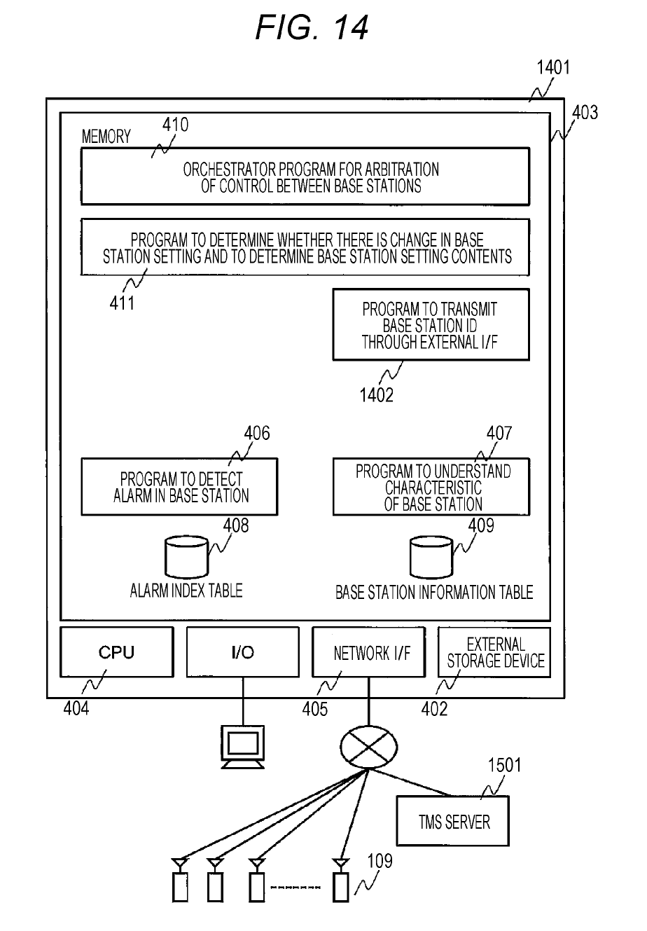

In FIG. 14, a configuration example of an EMS server 1401 of the present embodiment is illustrated. In a function of the EMS server 1401 in the present embodiment, the TMS server 1501 is added as a device connected through a network I/F 405 and a program 1402 to transmit, through the interface, an ID of a base station 109 to a TMS server 801 when alarm in the base station 109 is detected is included. The detection of an alarm in the base station 109 is performed by a program 406 to detect an alarm in a base station and a detection threshold of an alarm in the base station 109 is stored in an alarm index table 408.

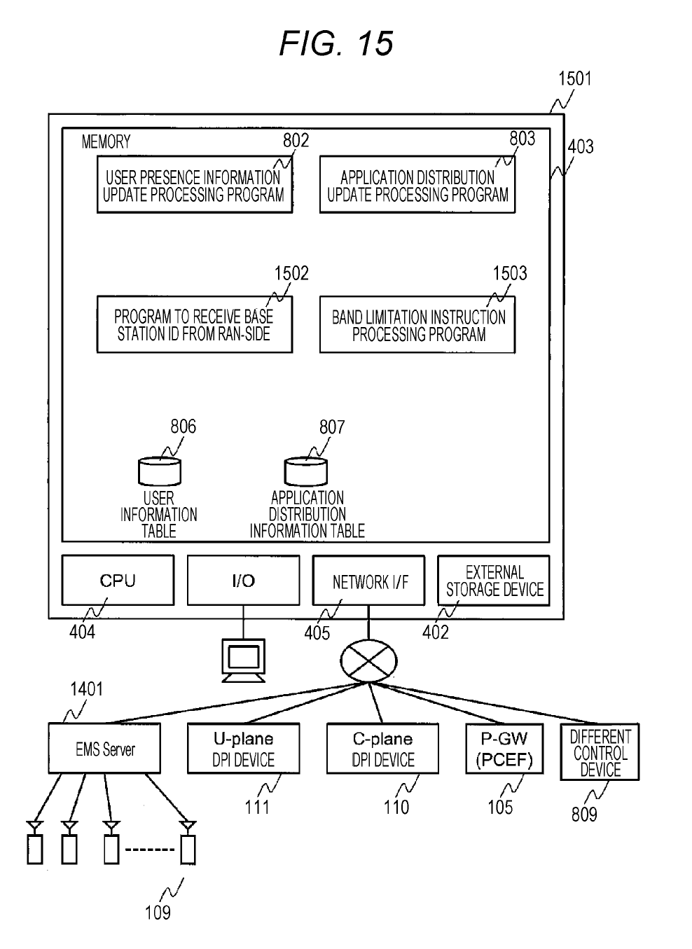

In FIG. 15, a configuration example of the TMS server 1501 in the present embodiment is illustrated. A function of the TMS server 1501 of the present embodiment is stored in a form of program software in an external storage device 402 of a general computer. The function of the EMS server 701 is expanded in a memory 403 and is executed by a CPU 404. Also, the TMS server 1501 communicates with DPIs 110 and 111 and a P-GW 105 through the network I/F 405. A communication function with respect to a different control device 809 such as a PCRF 202 may be included. A memory 403 of the TMS server 1501 stores a program 1502 to receive an ID of a base station to be controlled from a side of the EMS server 1401, a band limitation instruction processing program 1503 to determine a user to be traffic-controlled among users connected to the corresponding base station and to give a control instruction in addition to a user presence information update processing program 802 and an application distribution update processing program 803. Also, the memory 403 of the TMS server 1501 stores a user information table 806 to manage an IP address, a connection destination, and an in-use application of each user while associating these to each other and an application distribution information table 807 to hold application distribution of each base station.

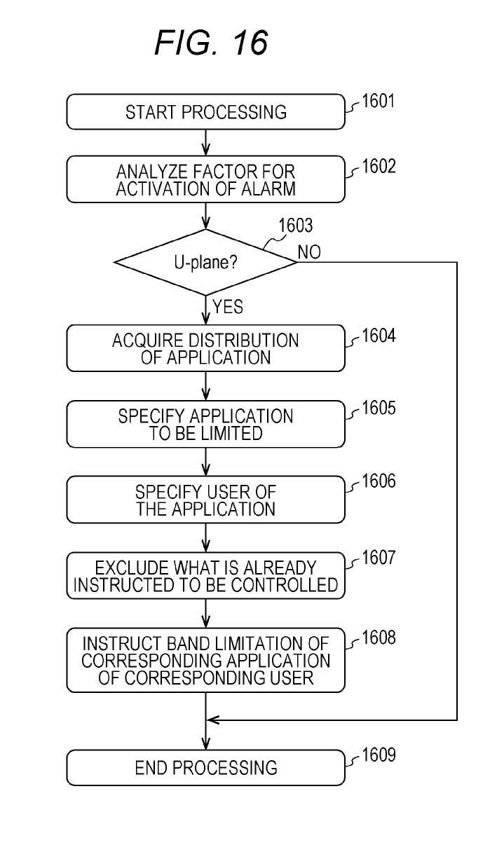

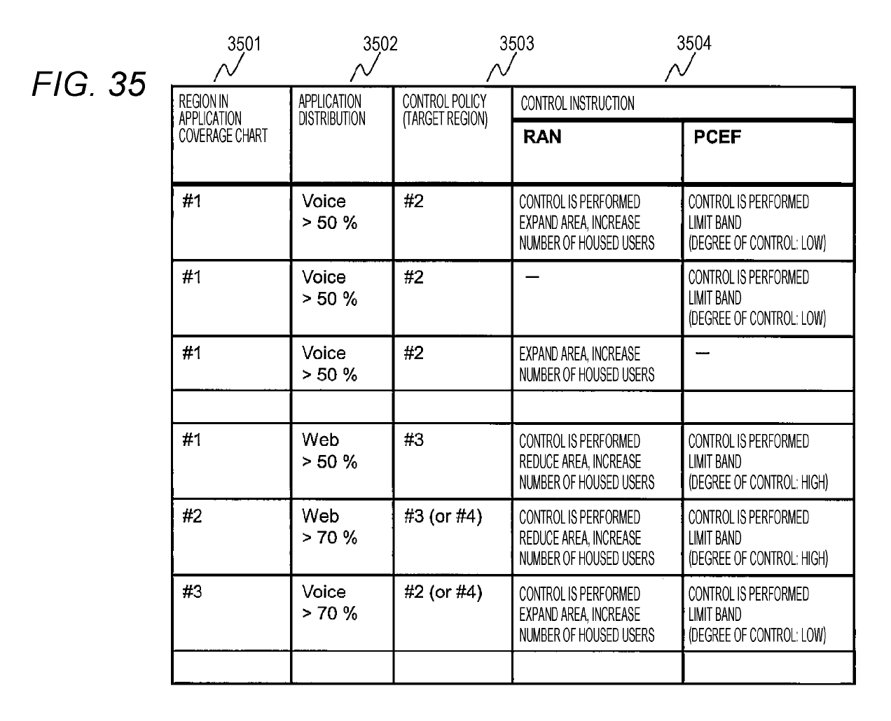

In FIG. 16, an example of a detail processing flow of the band limitation instruction processing program 1503 is illustrated. The band limitation instruction processing program 1503 is executed when alarm information received from the EMS server 1401 is acquired (1601). The band limitation instruction processing program 1503 analyzes a factor of activation of an alarm based on the received alarm information and pieces of information acquired from the user information table 806 and the application distribution information table 807 (1602). More specifically, alarm information is analyzed whether the factor of the activation of an alarm is due to U-plane traffic. For example, it is analyzed whether the received alarm information is an alarm directly related to call control such as connection or an alarm which may be activated by congestion of a base station or degradation of throughput regardless of call control. As a result of the analysis, when it is determined that the factor of the activation of an alarm is not the U-plane traffic (1603), the processing is ended (1609). When it is determined that the factor of the activation of an alarm is the traffic of the U-plane (1603), application distribution in the corresponding base station 109 is acquired (1604) and one or more applications to be limited are specified (1605). As an example of a method to specify an application to be limited, there is a method to perform specification in an order of band width consumption in a whole base station, a method to perform specification according to priority previously set by an administrator, or a method to perform specification by combining these methods. After the application to be controlled is specified (1605), the band limitation instruction processing program 1503 uses the user information table 806 and specifies a user using the corresponding application (1606). Here, what is already instructed to be band-limited with respect to the specified user and application is excluded (1607), an instruction of band limitation is given to the PCEF 106 or the PCRF 202 (1608), and the processing is ended (1609). As indicated in a part on a PCEF-side in 3504 in FIG. 35, as an example of a control policy, it is made possible to set a degree of band limitation at a plurality of levels. For example, when a degree of band limitation is low, the maximum band is set at 500 kbps and when a degree of band limitation is high, the maximum band is set at 200 kbps.

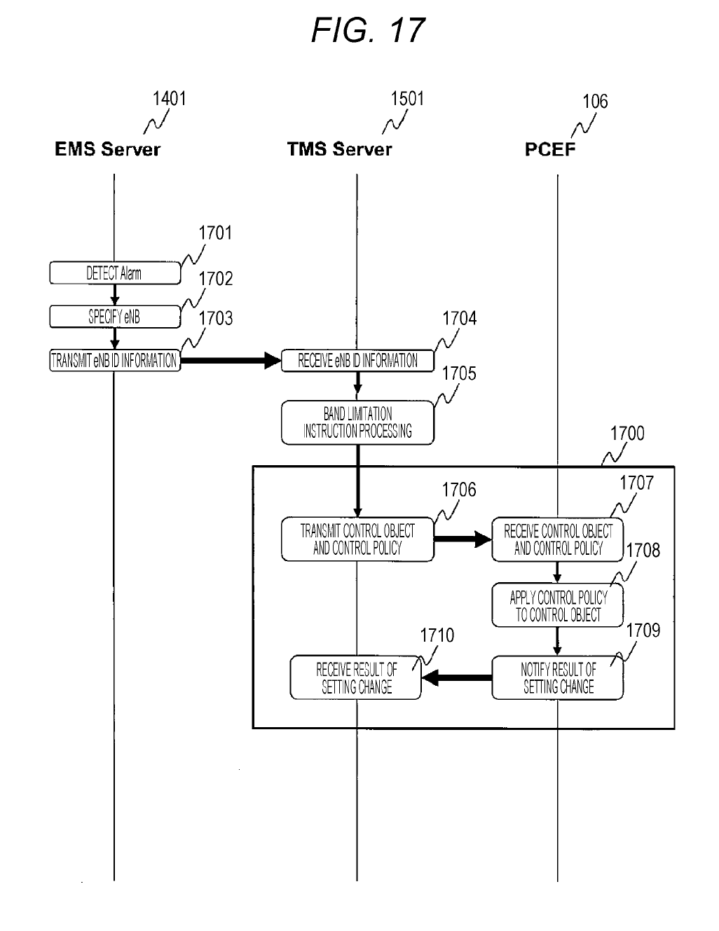

In FIG. 17, a series of processing sequence which is performed between the EMS server 1401 and the TMS server 1501 with the alarm detection in the EMS server 1401 as a trigger is illustrated.

Here, the series of processing sequence is executed when an alarm is detected in the EMS server 1401 (1701). There are the following two cases in the alarm detection in the EMS server 1401. That is, a case where an alarm transmitted from the base station 109 is detected (trap) and a case where it is determined by the EMS server 1401 that there is a problem based on statistical information (such as the number of times of connection failure) periodically-transmitted from the base station 109 and an alarm is detected. When detecting an alarm, the EMS server 1401 specifies a base station 109 which is a target of the alarm (1702) and transmits a base station ID and alarm information to the TMS server 1501 (1703). Note that as described later, the EMS server 1401 may transmit only a base station ID to the TMS server 1501. When receiving the alarm information from the EMS server 1401 (1704), the TMS server 1501 specifies a control target (terminal device using specific application) with the band limitation instruction processing program 1503 (1705) and transmits the control target and a control policy to the PCEF 106 (1706). When receiving the control target and the control policy from the TMS server 1501 (1707), the PCEF 106 applies the control policy to the control target (1708). Then, the PCEF 106 notifies a result of the setting change to the TMS server 1501 (1709). The TMS server 1501 receives the result of the setting change (1710).

Note that the series of sequences from the sequence 1706 to the sequence 1710 is referred to as a PCEF control sequence 1700. The PCEF control sequence 1700 is executed with a control target and a control policy, an application and user to be band-limited, or detail control contents such as designation of a degree of band limitation being input.

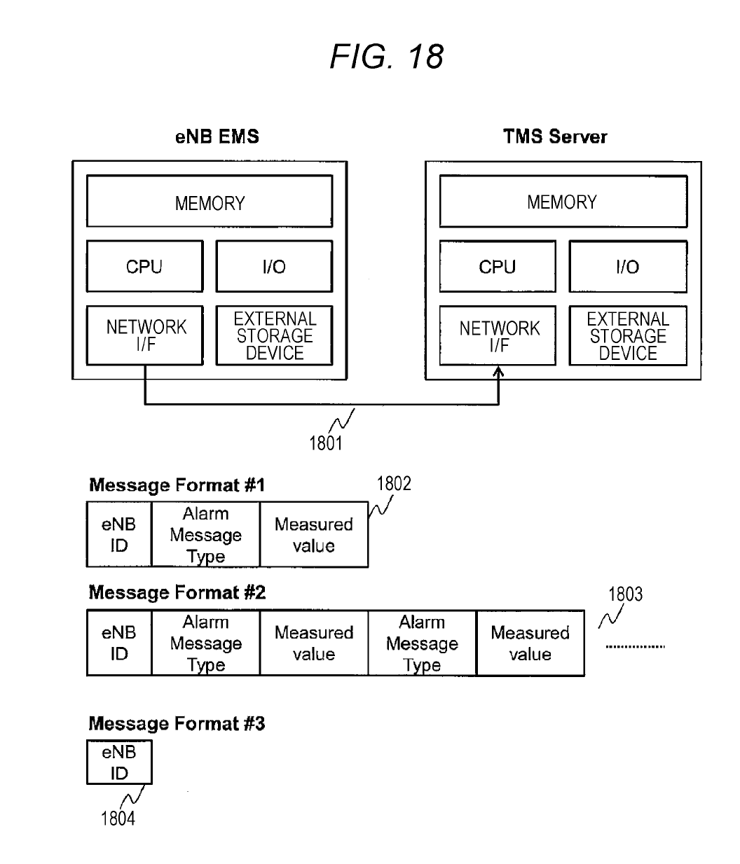

In FIG. 18, a detail example of a message communicated between the EMS server 1401 and the TMS server 1501 is illustrated. In the present embodiment, as indicated in 1801, a message is transmitted from the EMS server 1401 to the TMS server 1501. Note that there may be a message from the TMS server 1501 to the EMS server 1401 such as a response to the message transmitted from the EMS server 1401 to the TMS server 1501. When detail alarm contents in the base station 109 is transmitted from the EMS server 1401, as indicated in 1802, a set of an ID of the base station 109, a type of an alarm, and a detail measurement value of the alarm is transmitted as a format of the message transmitted at this time. When a plurality of alarms is detected with respect to one base station, a plurality of pieces of alarm information may be juncturally transmitted, as indicated in 1803. Alternatively, detail alarm contents may not be transmitted from the EMS server. As indicated in 1804, only an ID of the base station in which an alarm is activated may be transmitted.

### Third Embodiment

In the present embodiment, in a case where it is difficult to improve communication quality in a specific area (base station) even when traffic control is performed in a TMS server 2101 with respect to a specific application in the specific area, an instruction is given to an EMS server 2001 to change a system parameter in a base station 109. Accordingly, communication quality for a user is improved compared to a case of performing only traffic control. Also, since it is possible to reduce the number of times of changing a system parameter in a base station in operation, it also becomes possible to control a quality variation in a whole area which variation is caused along with a change of a system parameter in a base station.

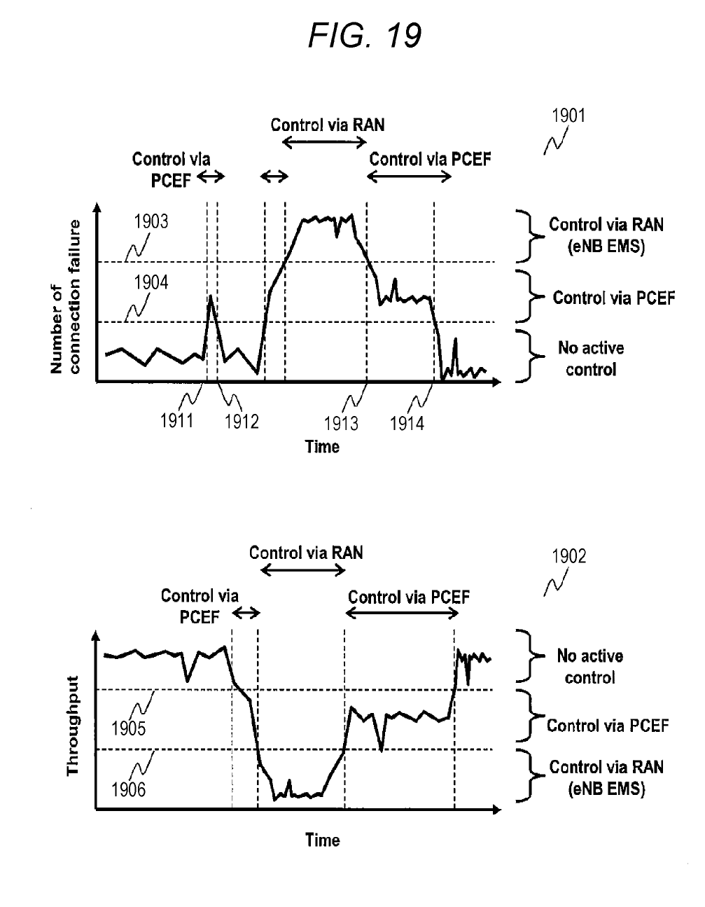

FIG. 19 is a graph illustrating of an operation concept of the present embodiment. In this example, an example of an operation concept of when the number of times of connection failure is acquired as an example of information on a side of a control signal which information can be acquired in the EMS server 2001 and when a base station throughput is acquired as an example of information on a side of user traffic which information can be acquired in the TMS server 2101 through a DPI is illustrated. When it is not possible to directly acquire a base station throughput from the DPI, for example, it is possible to separate all pieces of measured traffic for each base station by using a base station identifier 302 in the table in FIG. 3, to extract traffic related to each user connected to the base station by using a user identifier, and to calculate the base station throughput from the sum of an extracted traffic amount per unit time of the corresponding user.

In an example of monitoring the number of times of connection failure (1901), a degree of quality deterioration is evaluated in two stages and a degree of control is adjusted. That is, when slight quality deterioration is detected, that is, in a case where the number of times of connection failure exceeds a first quality deterioration threshold (1904) but does not exceed a second quality deterioration threshold (1903), traffic control by a PCEF 106 is performed to solve the quality deterioration. When the quality deterioration is solved by the traffic control, the control is released (1912). On the other hand, when quality deterioration becomes more severe and exceeds the second quality deterioration threshold (1903), an instruction of setting change in the base station is given to the EMS server 2001 to improve the quality deterioration. Here, the traffic control to the PCEF 106 includes the method described in the second embodiment and the instruction of setting change in the base station 109 includes the method described in the first embodiment.

Similarly, in an example of monitoring the base station throughput (1902), a degree of quality deterioration is evaluated in two stages and a method of control is determined.

In the above two examples, an example of evaluating quality deterioration in two stages by using two quality deterioration thresholds and changing a control method has been described. However, a method to determine a control method by combining two or more indexes may be used. For example, it is determined that indexes of both of the number of times of connection failure and the base station throughput are in quality deterioration, an instruction of setting change in the base station is given through an EMS server and when it is determined that only one index is in quality deterioration, traffic control with respect to the PCEF 106 is performed.

Note that in the present embodiment, an example in which traffic control in the PCEF 106 is performed in a slight quality deterioration state and setting in the base station is changed in a severe quality deterioration state. However, orders of control maybe switched. That is, a system in which base station setting is changed in the slight quality deterioration state and traffic control in the PCEF 106 is performed in the severe quality deterioration state may be used.

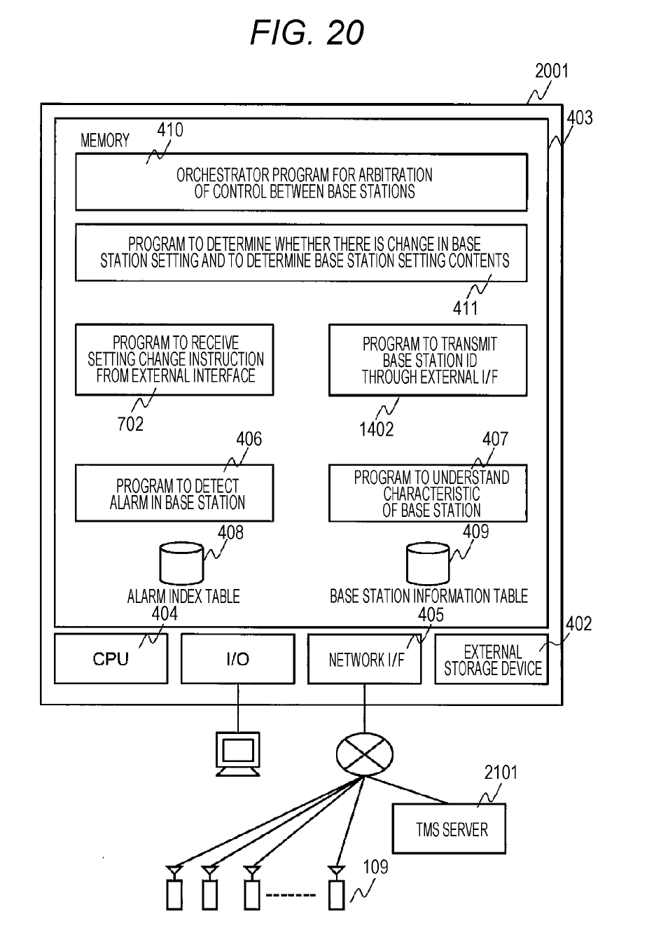

In FIG. 20, a configuration example of the EMS server 2001 of the present embodiment is illustrated. In a function of the EMS server in the present embodiment, a program 1402 to transmit abase station ID through an external I/F which program is added in the second embodiment is included in addition to the function in the first embodiment illustrated in FIG. 7.

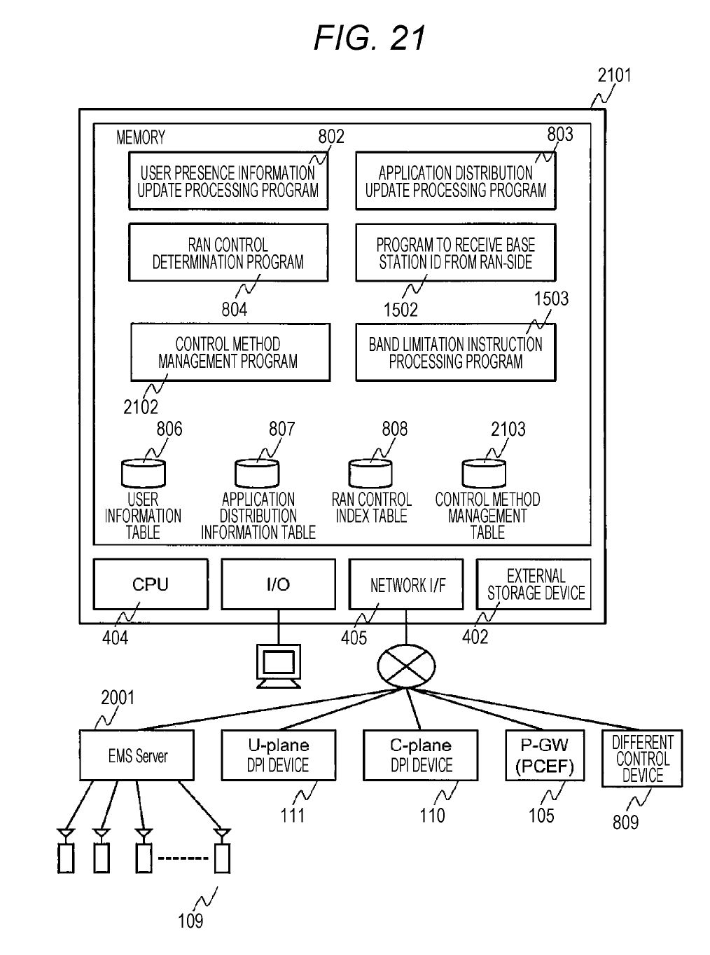

In FIG. 21, a configuration example of the TMS server 2101 of the present embodiment is illustrated. A function of the TMS server 2101 of the present embodiment is stored in a form of program software in an external storage device of a general computer. The function of the TMS server 2101 is expanded in a memory and is executed by a CPU. Also, the TMS server 2101 communicates with DPIs 110 and 111 and a P-GW 105 through a network I/F. A communication function with respect to a different control device 809 such as a PCRF may be included. A memory of the TMS server 2101 stores a control method management program 2102 to determine a control method based on information acquired from the EMS server 2001 or a quality index acquired from the DPIs 110 and 111 in addition to a user presence information update processing program 802, an application distribution update processing program 803, and a program 1502 to receive a base station ID from a RAN-side. In addition, in a case of controlling the PCEF, a band limitation instruction processing program 1503 to determine a user to be traffic-controlled among users connected to a base station and to give a control instruction and a RAN control determination program 804 to control a RAN are stored. Also, a memory of the TMS stores a user information table 806 to manage an IP address, a connection destination, and an in-use application of each user while associating these to each other, an application distribution information table 807 to hold application distribution in each base station, a RAN control index table 808 to be an index of RAN control, and a control method management table 2103 to store a control method corresponding to a quality index value.

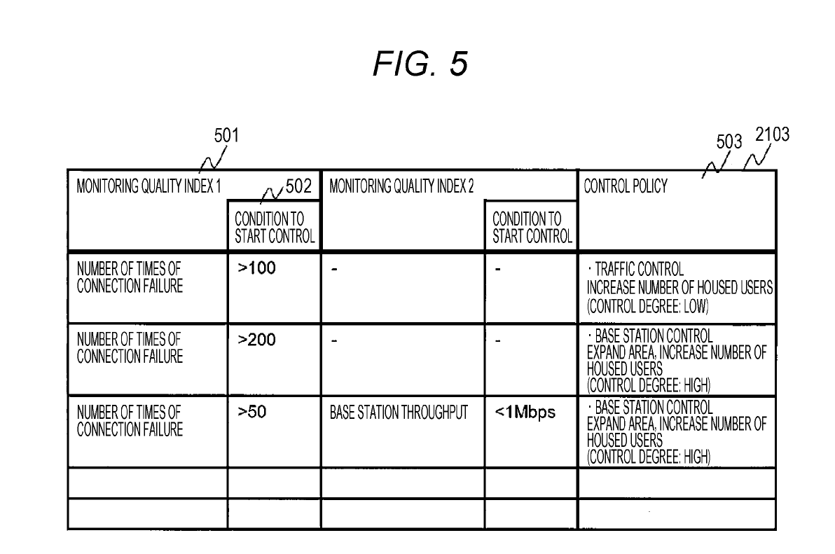

In FIG. 5, an example of the control method management table 2103 stored in the memory in the TMS server 2101 in the present embodiment is illustrated. The control method management table 2103 includes one or more monitoring quality indexes 401, a condition to start control 502 based on the index value, and a control policy 503. In the monitoring quality index, an item name to uniquely identify a quality index such as the number of times of connection failure or a base station throughput value is stored. In the condition to start control 502, a value of the corresponding index value a degree of deterioration of which is to be determined is stored. In the control policy 503, a control policy or control contents of when a condition to start control is satisfied in all monitoring index values is stored.

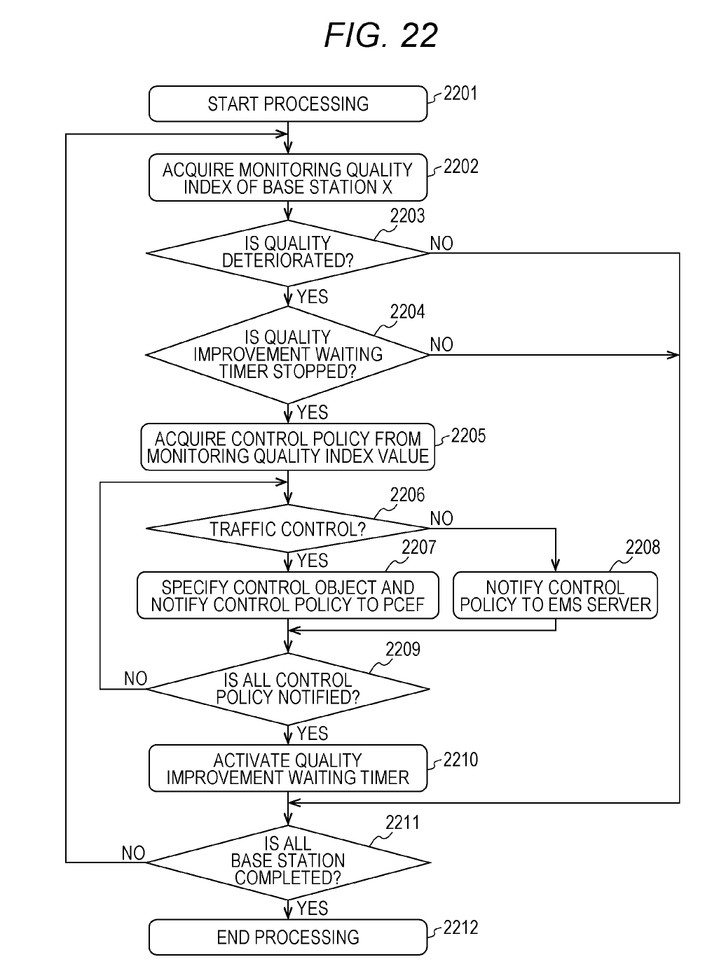

In FIG. 22, an example of a processing flow of the control method management program 2102 is illustrated. The control method management program 2102 starts processing when a quality index is acquired from the EMS server 2001 or the DPIs 110 and 111. Alternatively, processing may be started periodically.

The control method management program 2102 acquires a quality index value of a monitored base station X from the EMS server 2001 and/or the DPIs 110 and 111 (2202) and determines whether a condition to start control in the control method management table is satisfied, whereby it is determined whether there is quality deterioration (2203). When quality deterioration in the corresponding base station is not detected (2203), the processing in the corresponding base station is ended. When quality deterioration is detected (2203), it is checked whether a quality improvement waiting timer with respect to the corresponding base station is stopped (2204). The quality improvement waiting timer is a timer which is set after the control is performed (step 2210) and which is used to set a time to evaluate an effect of the control performance as a timer value and to prevent the control from being performed again during activation of the timer. When the quality improvement waiting timer is stopped (2204), the control method management table 2103 is searched based on a monitoring quality index value and a control policy is acquired (2205). As a method to acquire the control policy, there are a method to acquire all control policies which satisfy the condition to start control, a method to acquire only a control policy with the most strict condition to start control, a method to acquire only a highest control policy in an entry which satisfies the condition to start control, and the like. The method is designated previously by an administrator. When the acquired control policy is traffic control (2206), a control target is specified and the control policy of the traffic control is notified to the PCEF (2207). Here, processing to specify the control target corresponds to step 1604 to step 1607 in the processing flow of the band limitation instruction processing program. When the acquired control policy is not the traffic control (2206), the control policy of the base station is notified to the EMS server (2208). Note that in the notification of the control policy to the PCEF (2207), the PCEF control sequence 1700 is executed between the TMS server 2101 and the PCEF. In the notification of the control policy to the EMS server (2208), the base station control sequence 1100 is executed between the TMS server 2101 and the EMS server 2001. When the notification with respect to all control policies acquired in step 2205 is completed (2209), the quality improvement waiting timer of the corresponding base station is activated (2210) and the processing of the corresponding base station is ended. When the processing is completed with respect to all base stations (2211), the control method management program is ended (2212).

A format of an interface between the EMS server and the TMS server and that of a message exchanged therebetween may be identical to what is described in the first embodiment. There are the following two cases which are a case where a detail system parameter and a setting value thereof are notified from the TMS server to a specific base station and a case where only a control policy is notified from the TMS server to the EMS server and where a detail system parameter or a setting value thereof is determined by the EMS server.

### Fourth Embodiment

In the present embodiment, an effective service area of each application is visualized by acquiring information of a service area in each base station through an EMS server and combining application distribution of each base station which distribution is acquired in a traffic management server. Accordingly, since a place of installation in facility investment for a base station can be determined not only according to a simple radio wave state but also according to an actual condition of usage of an application, consideration of effective facility investment becomes possible.

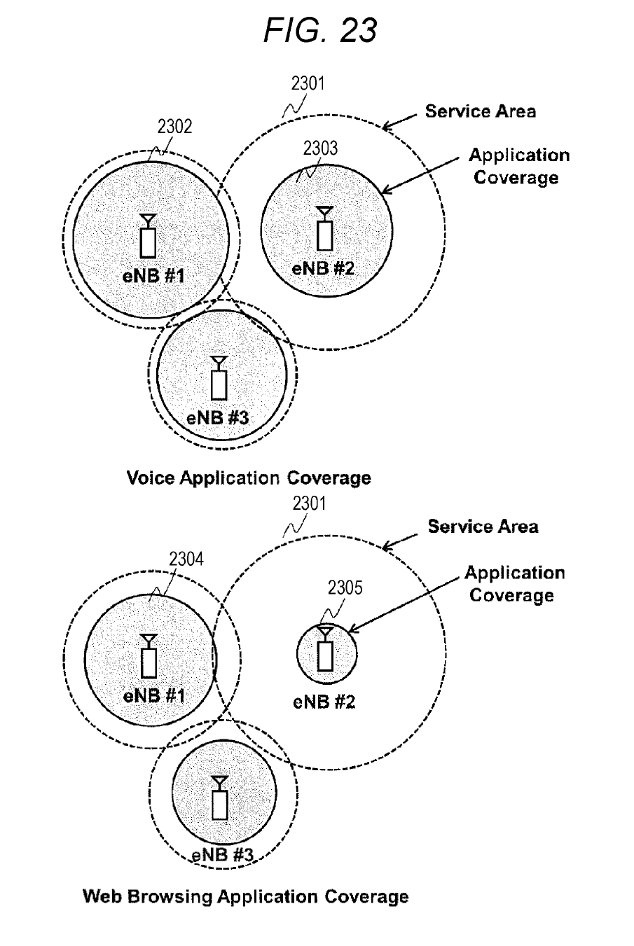

In FIG. 23, an example of a service area of each application visualized in the present embodiment is illustrated. A service area of each base station which area is acquired through the EMS server is in a range indicated in 2301. In this view, visualization is performed concentrically with a base station as a center. However, an actual service area may be displayed based on a geological feature or actual measurement. Here, each of 2302 and 2303 indicates a voice service area in which voice communication can be performed comfortably in each base station. While an example in which a voice service can be used comfortably in almost whole region in the service area is indicated in eNB #1, an example in which a voice service can be used comfortably only in a concentric area with a half of a radius of the service area is indicated in eNB #2. Also, the following example is illustrated. That is, service areas of applications are displayed with different sizes as indicated in 2304 and 2305 since indexes of quality of experience (QoE) for comfortable usage are different in different applications.

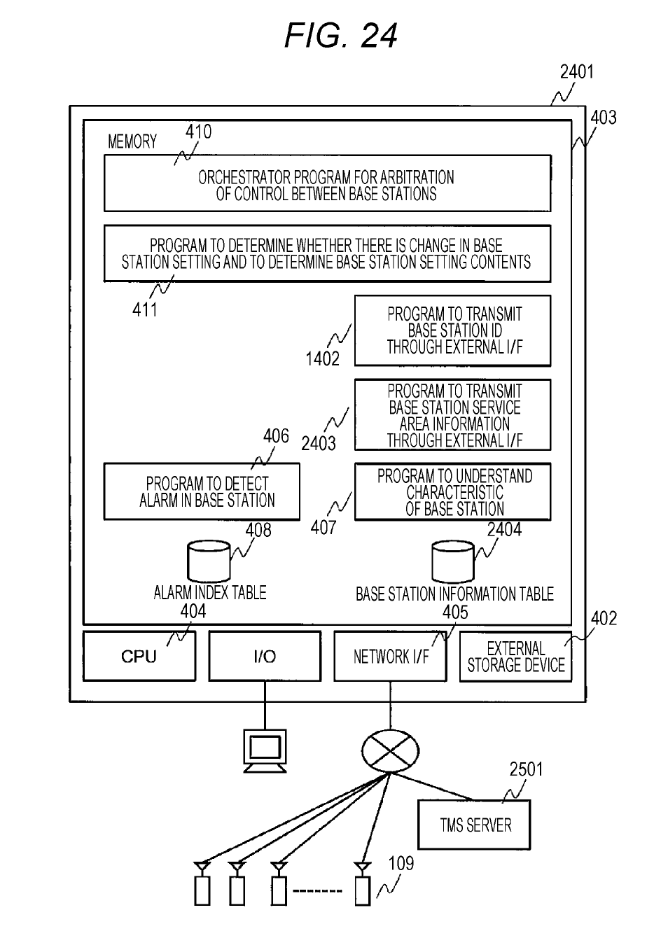

In FIG. 24, a configuration example of an EMS server 2401 of the present embodiment is illustrated. To the EMS server 2401 in the present embodiment, a TMS server 2501 is connected through a network I/F. Also, in the EMS server 2401, programs 1402 and 2403 to transmit an ID of a base station or information related to a service area in a base station to a TMS server-side through the interface are included. Also, the EMS server 2401 directly acquires information which is related to a service area of a base station and which includes a system parameter and the like of the base station from the base station through a connection interface with the base station and includes a base station information table 2404 to store the information related to the service area of the base station.

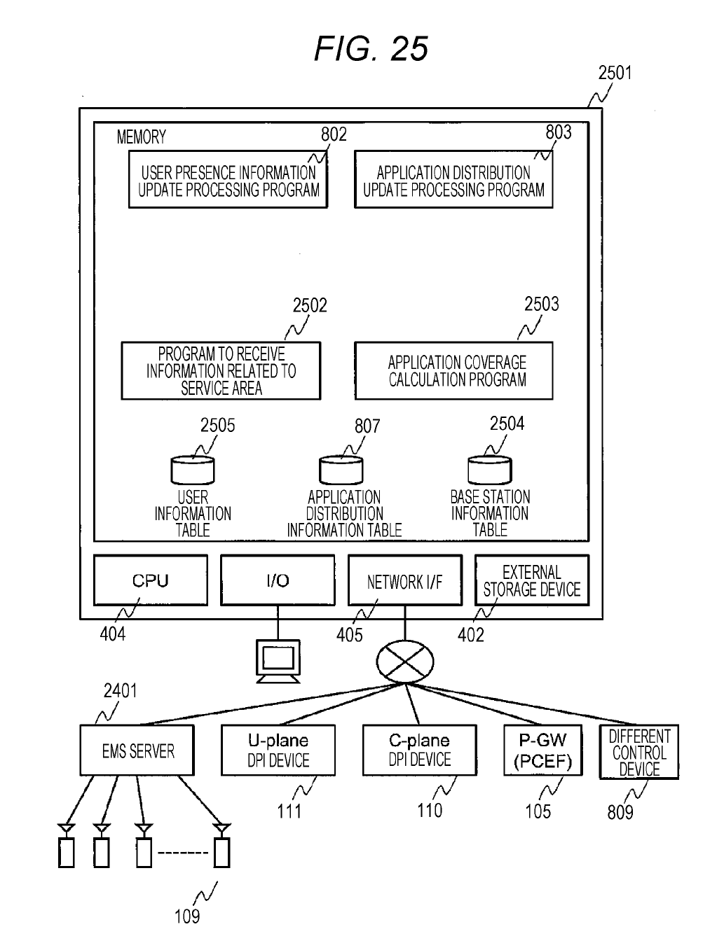

In FIG. 25, a configuration example of the TMS server in the present embodiment is illustrated. A function of the TMS server of the present embodiment is stored in a form of program software in an external storage device of a general computer. The function of the TMS server is expanded in a memory and is executed by a CPU. Also, the TMS communicates with the EMS server 2401, DPIs 110 and 111, and a P-GW 105 through the network I/F. A communication function with respect to a different control device 809 such as a PCRF may be included. A memory of the TMS server stores a program 2502 to receive service area information of each base station and an application coverage calculation program 2503 to calculate a service area of each application based on service area information of each base station and application distribution of each base station in addition to a user presence information update processing program 802 and an application distribution update processing program 803. Also, the memory of the TMS server stores a user information table 2505 to manage an IP address, a connection destination, and an in-use application of each user while associating these to each other, an application distribution information table 807 to hold application distribution of each base station, and a base station information table 2504 to store information of each base station.

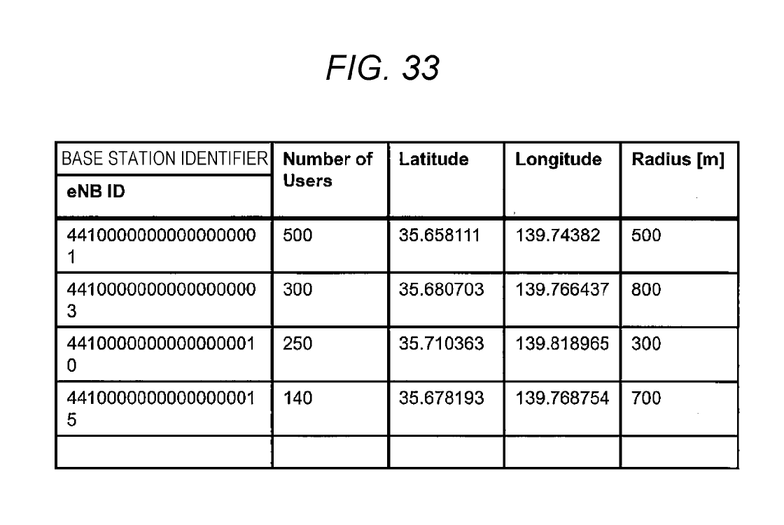

In FIG. 33, an example of the base station information table 2504 held by the TMS server 2501 is illustrated. The base station information table 2504 holds an identifier (eNB ID) of each base station, the number of connection users, and service area information. In the example in FIG. 33, a service area includes an installation site of a base station indicated by longitude and latitude and a cell radius.

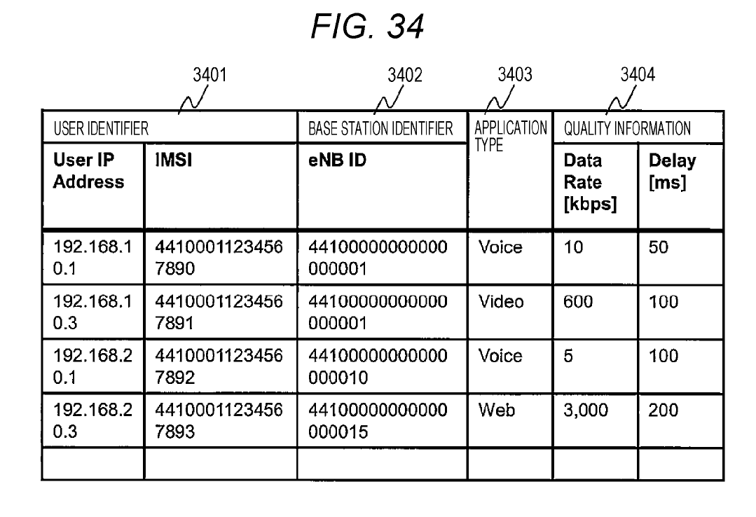

FIG. 34 is an example of the user information table 2505 held by the TMS server 2501. The TMS server 2501 stores user information of each user, which information is acquired from the DPIs 110 and 111, into the user information table 2505. The user information includes a user identifier 3401, a base station identifier 3402, an application type 3403, and quality information 3404. The user identifier 301 is used to identify a user uniquely. The user information table 2505 includes, as the user identifier 3401, at least one kind of identifier. In the example in FIG. 34, a user IP address and an IMSI are employed as the user identifier 3401. The base station identifier 3402 is used to uniquely identify a base station where a user is present. In the example in FIG. 34, an eNB ID is employed as the base station identifier 3402. The application type 3403 is a type of an application used by a user. In the example in FIG. 34, the quality information 3404 includes a data rate and a delay. Here, the data rate and the delay are respectively a data rate and a delay of traffic of each user which are measured by the DPI. It is assumed that these values are directly output from the DPI. However, when the DPI does not output on a granularity of traffic of each user, the traffic may be separated for each user by using the user identifier 301 illustrated in FIG. 3 and traffic or a delay of each user may be calculated based on a traffic amount per unit time of each user or a necessary time thereof.

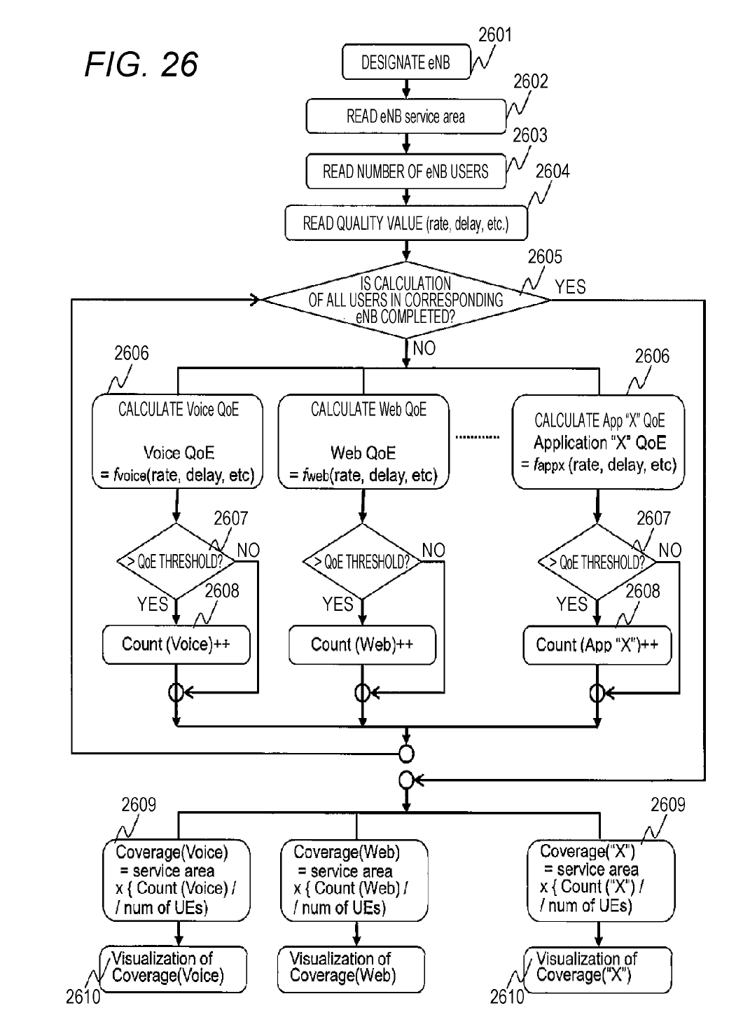

In FIG. 26, a flow of application coverage calculation processing 2503 performed in each base station by the TMS server 2501 is illustrated. First, the TMS server 2501 designates a base station to be calculated in step 2601. Then, in step 2602, the TMS server 2501 reads, from the base station information table 2504, information of a service area of the corresponding base station. In step 2603, the TMS server 2501 reads the number of connection users in the corresponding base station from the base station information table 2504. In step 2604, from the user information table 2505, the TMS server 2501 selects a user connected to the corresponding base station and reads quality information of each selected user. Then, the TMS server 2501 counts the number of users which satisfy certain quality with respect to each application type (step 2605 to 2608). In step 2606, the TMS server 2501 calculates a quality index (QoE) of a certain user. The QoE is a function which is defined with the quality information read in step 2604 as a parameter and which is set previously. In step 2607, the TMS server 2501 determines whether the QoE calculated in step 2606 exceeds a threshold. The threshold used in step 2607 is set previously for each application type. When the QoE exceeds the threshold (Yes in step 2607), the TMS server 2501 counts up the number of users in step 2608. After step 2606 to step 2608 are performed with respect to all users connected to the corresponding base station, the TMS server 2501 calculates application coverage with respect to each application type in step 2609. The application coverage is calculated from the service area acquired in step 2602 and a QoE satisfaction rate of each application type. The QoE satisfaction rate is acquired by dividing the number of users, which is acquired as a result of step 2605 to step 2608 and the QoE of each of which users exceeds the threshold in each application type, by the number of users of each application type. Then, in step 2610, the TMS server 2501 outputs information of the calculated application coverage to an external display device, whereby visualization of the application coverage is performed as illustrated in FIG. 23.

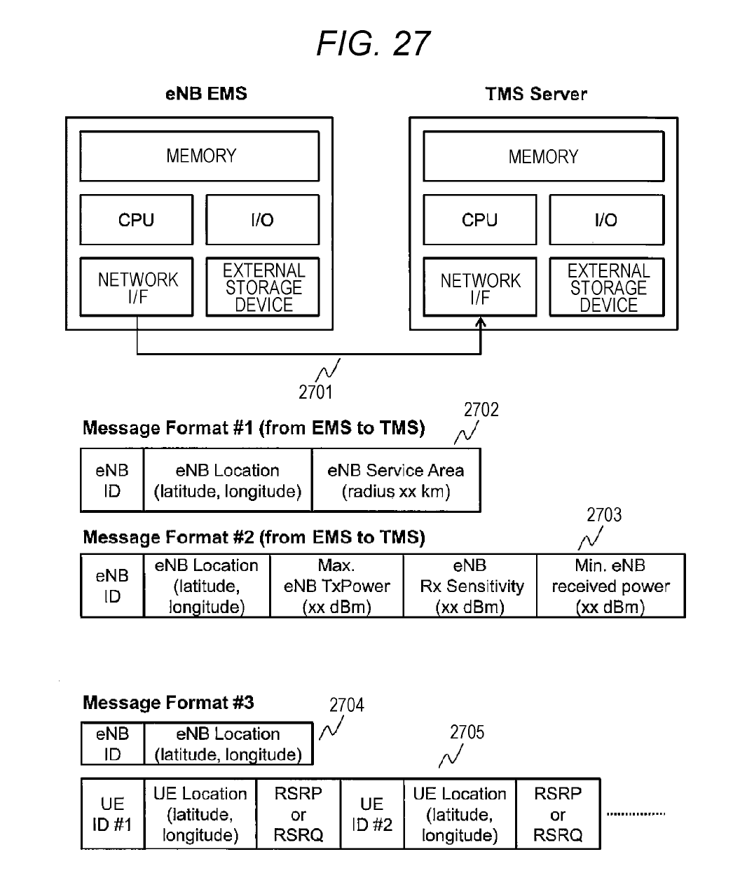

In FIG. 27, a detail example of a message communicated between the EMS server and the TMS server is illustrated. In the present embodiment, as indicated in 2701, a message is transmitted from the EMS server to the TMS server. Note that there may be a message from the TMS to the EMS server such as a response to the message transmitted from the EMS server to the TMS server. When a position of each base station and an about radius of a service area thereof are transmitted from the EMS server, a format of the message transmitted at this time becomes what is indicated in 2702. When it is not possible to present the service area as a distance, as indicated in 2703, pieces of information such as a position of each base station, transmission power of the base station, reception sensitivity of the base station, and a reception power value actually-received in the base station may be transmitted, for example. In this case, a distance of a service area is calculated approximately on the TMS server-side from these power values. A method to calculate a distance from the power values approximately is not an essential part of the embodiment of the present invention, and thus, a description thereof is omitted. In a case of message formats 2702 and 2703, basically, a service area of a base station is drawn concentrically with a position of the base station as a center.

As a method to recognize a service area corresponding to an actual condition, a structure of minimization of drive tests (MDT) prescribed by a 3GPP may be used and the service area may be calculated based on the result. More specifically, based on a 3GPP TS 37.320, by using a system which is called an Immediate MDT and in which a report is given from a terminal in a CONNECTED state, RSRP or RSRQ, which corresponds to a reception characteristic of a radio channel, or a position of a terminal (UE) is eventually collected from the terminal to the EMS server through a base station eNB and pieces of the collected information 2704 and 2705 are transmitted to a traffic management server. In the traffic management server, these pieces of information are mapped on a map and an area with the minimum reception sensitivity or more is drawn as a service area.

### Fifth Embodiment

In the present embodiment, based on variation of application coverage calculated in the fourth embodiment or a usage rate of an application in each base station, control to improve user quality of experience (QoE) is performed. Accordingly, it becomes possible to improve communication quality of individual user and to expand an area in which a user can use an application with satisfaction.

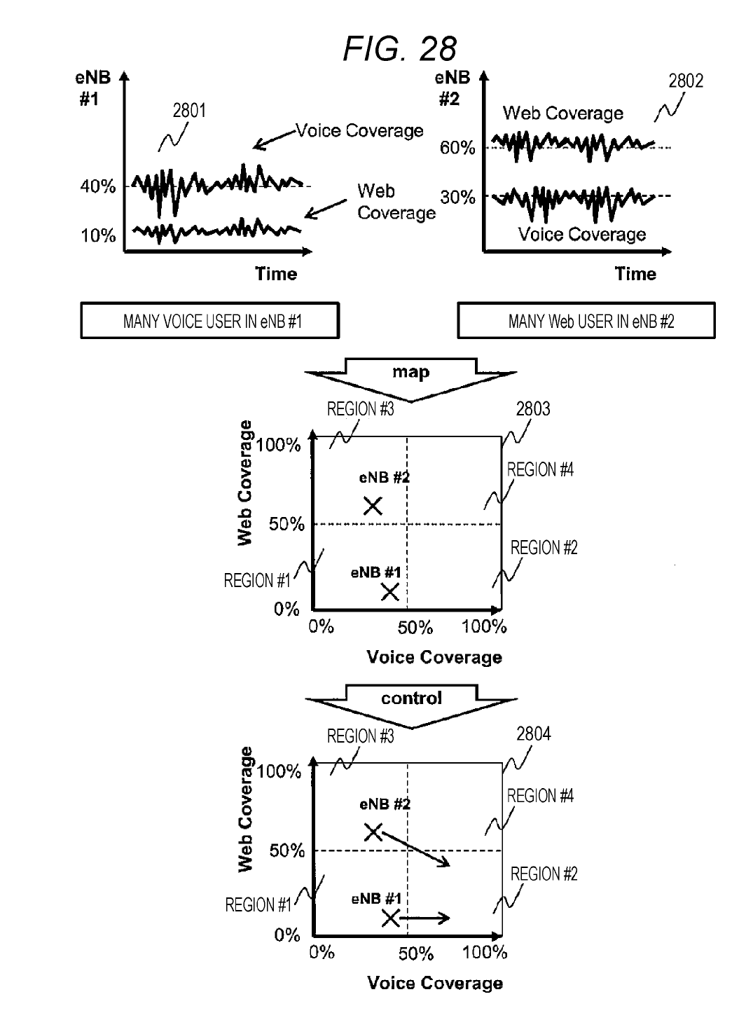

In FIG. 28, an operation concept of the present embodiment is illustrated. Here, 2801 indicates a state in which voice application coverage (relative value of when service area of base station is 100%) and web browsing coverage (relative value of when service area of base station is 100%) in a base station #1 vary temporally. Also, 2802 indicates a similar state in a base station #2. In this example, two applications of voice and web browsing are graphed. However, a different application can be also graphed in a similar manner.

Next, a temporally-varying service area of each application is mapped in an application coverage chart. Here, 2803 in FIG. 28 is an example of an application coverage chart. The application coverage chart 2803 is divided into four regions. A base station #1 is mapped in a region #1 in which both of coverage of a sound application and coverage of web browsing are small. A base station #2 is mapped in a region #3 in which coverage of a sound application is small and coverage of web browsing is large. In the example in FIG. 28, since the two applications of voice and web browsing are used, a graph includes two axes. However, in a case where there are three or more applications, an N-dimensional graph can be created similarly. Also, in the example in FIG. 28, the application coverage chart is divided into four regions but the number of regions may be a value other than four. By increasing the number of regions, more precise control can be performed.

Next, a control policy for improving quality of experience (QoE) of a user is determined in consideration of a position on the application coverage chart and application distribution of a user connected to a base station. In the example in FIG. 28, in the base station #1, coverage is small even with respect to a sound application which does not require much band. Thus, first, control is performed in such a manner that the coverage of the sound application is improved toward the region #2 in the application coverage chart as indicated in 2804. Also, in the base station #2, coverage of a sound application used by many users is small although coverage of web browsing is large. Thus, control is performed in such a manner that the coverage of the sound application is improved toward the region #2 (or region #4) in the application coverage chart as indicated in 2804.

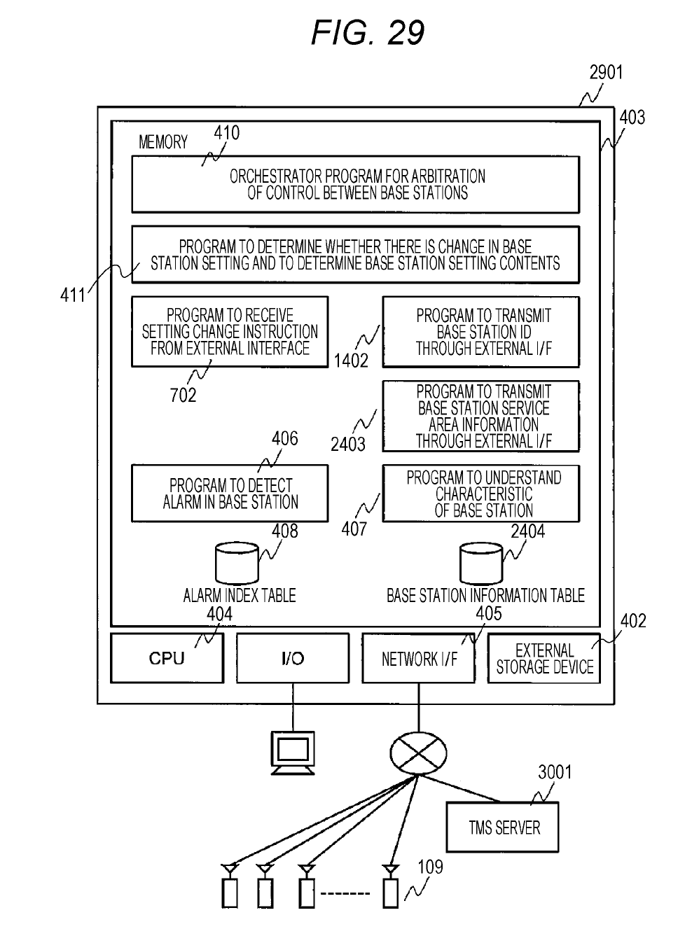

In FIG. 29, a configuration example of an EMS server 2901 of the present embodiment is illustrated. The EMS server in the present embodiment is connected to the TMS server 801 through a network I/F. The EMS server includes a program 1402 to transmit an ID of the base station through the interface, a program 2403 to transmit information related to a service area of the base station to the TMS server-side, and a program 702 to receive a setting change instruction of the base station from the TMS server 801. Also, the EMS server 2901 includes a base station information table 2404 to store the information related to the service area of the base station.

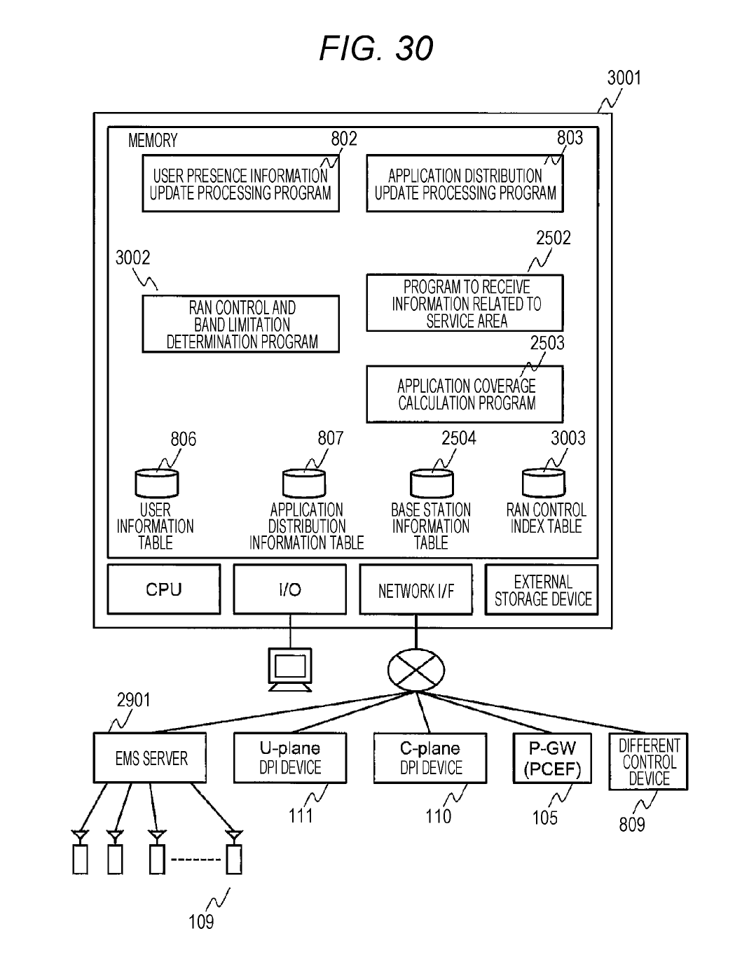

In FIG. 30, a configuration example of the TMS server in the present embodiment is illustrated. A function of the TMS server of the present embodiment is stored in a form of program software in an external storage device of a general computer. The function of the TMS server is expanded in a memory and is executed by a CPU. Also, the TMS server communicates with the EMS server 2901, the DPIs 110 and 111, and the P-GW 105 through the network I/F. A communication function with respect to a different control device 809 such as a PCRF may be included. A memory of the TMS server stores a program 2502 to receive the information related to the service area of each base station which information is acquired from the EMS server 2901 and an application coverage calculation program 2503 to calculate a service area of each application based on the service area information of each base station and application distribution of each base station in addition to a user presence information update processing program 802 and an application distribution update processing program 803. Also, a RAN control and band limitation determination program 3002 is stored. In addition, the memory of the TMS server stores a user information table 806 to manage an IP address, a connection destination, and an in-use application of each user while associating these to each other, an application distribution information table 807 to hold application distribution in each base station, and a base station information table 2504 to store information of each base station. Moreover, the TMS server stores a RAN control index table 3003.

FIG. 35 is an example of the RAN control index table 3003 held by a TMS server 3001. The RAN control index table 3003 includes a region 3501 in the application coverage chart, application distribution 3502, a control policy 3503, and a control instruction 3504. The control policy 3503 is a region in the application coverage chart which region is to be a target of a result of control. The control instruction 3504 is a control instruction to each of a RAN and a PCEF. In FIG. 35, the control on the RAN is, for example, to “expand an area and to increase the number of housed users”. A detail control instruction is, for example, increasing an antenna tilt angle in the base station, increasing transmission power in the base station, or relaxing user connection limitation in the base station which instruction has been described in the RAN control index table 1001 in the first embodiment. In FIG. 35, an example of control on the PCEF is to “limit band (control degree: low) ”. This indicates, for example, application of band limitation to a user using a video application in the corresponding base station. A low control degree indicates that an upper limit value of a data rate in the band limitation is large (limitation is loose). For example, the RAN control index table 3003 is set previously. With respect to control on a RAN-side and control on a PCEF-side, first, control of a plurality of users is performed on the PCEF-side which operates in a short period of time (such as order of second) as a granularity of the control. Then, control is performed on the RAN-side which operates with a granularity of a relatively long period of time (such as order of several hours).

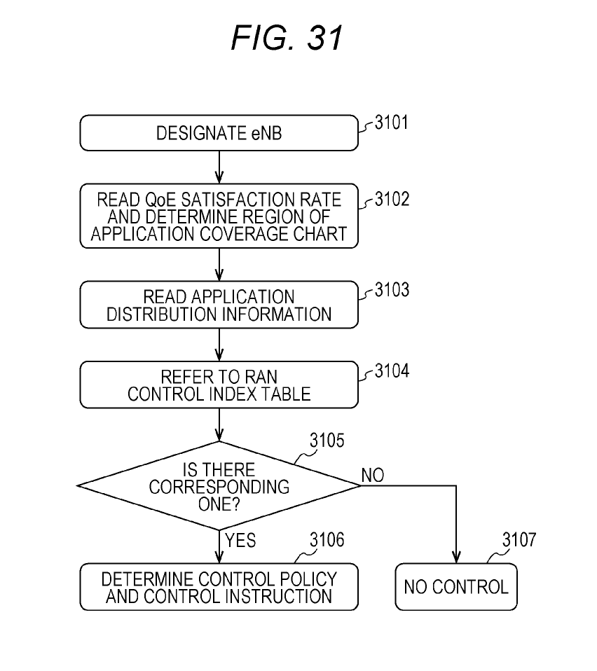

FIG. 31 is a flowchart of the RAN control and band limitation determination program 3002 held by the TMS server 3001. The TMS server 3001 performs an application distribution update processing program 803 with respect to each base station. The TMS server 3001 executes the RAN control and band limitation determination program 3002, for example, in a certain time cycle. In step 3101, the TMS server 3001 designates a target base station. In step 3102, the TMS server 3001 acquires a QoE satisfaction rate of the corresponding base station and determines that the corresponding base station is in which region in the application coverage chart. Note that the QoE satisfaction rate is the QoE satisfaction rate of each application type described in the fourth embodiment and is calculated by the application coverage calculation program 2503. In step 3103, the TMS server 3001 acquires application distribution information of the corresponding base station. Note that the application distribution information is the application distribution information described in the first embodiment and is held in the application distribution information table 807. In step 3104, the TMS server 3001 checks the region in the application coverage chart which region is determined in step 3102 and the application distribution information acquired in step 3103 with the region 3501 in the application coverage chart and the application distribution 3502 which are in the RAN control index table 2504. When there is a corresponding item (Yes in step 3104), a control policy and a control instruction are determined according to the corresponding item (step 3106). When there is no corresponding item (No in step 3104), control is not performed (step 3107).

After determining the control instruction, the TMS server 3001 performs control on the RAN when there is the control on the RAN and performs control on the PCEF when there is the control on the PCEF. A procedure of the control on the RAN is similar to the procedure (1100) of the control on the RAN in the first embodiment and a procedure of the control on the PCEF is similar to the procedure (1700) of the control described in the second embodiment.

A message communicated between the EMS server and the TMS server is transmitted bi-directionally between the EMS server and the TMS server. A format of the message transmitted at this time may be identical to those described in the first, third, and fourth embodiments.

What is claimed is:

1. A network system comprising:
a plurality of terminal devices;
a plurality of base stations configured to house the plurality of terminal devices;
a base station management server configured to manage the plurality of base stations;
a core network-side device connected to the plurality of base stations;
an analysis device configured to acquire a packet between the plurality of base stations and the core network-side device; and
a traffic management server connected to the analysis device,
wherein the base station management server and the traffic management server are connected to each other,
the base station management server performs control of the base stations,
the core network-side device performs traffic control of a specific terminal device, and
the traffic management server acquires information of an application used by the terminal device based on the packet and performs, based on the information of the application, at least one of control of the base stations and traffic control of the specific terminal device.

2. The network system according to claim 1, wherein the traffic management server
specifies, based on the packet, a type of an application used by the terminal devices,
counts the kind of the application in each base station and calculates application distribution in the base station, and
gives an instruction, based on the application distribution, to the base station management server to perform control of the base station.

3. The network system according to claim 1, wherein
when detecting an alarm in a specific base station, the base station management server transmits information of the specific base station to the traffic management server, and
the traffic management server calculates application distribution in the specific base station based on a type of an application used by a terminal device connected to the specific base station, and gives an instruction, based on the application distribution, the core network-side device to perform traffic control of the terminal device using a specific application.

4. The network system according to claim 1, wherein the traffic management server
specifies a base station with deteriorated quality,
calculates application distribution in the specified base station based on a kind of an application used by a terminal device connected to the specified base station, and
gives, based on the application distribution, an instruction to the base station management server to perform control of the specified base station and an instruction to the core network-side device to perform traffic control of a terminal device using a specific application.

5. The network system according to claim 1, wherein
the base station management server collects information of a service area of each of the base stations and transmits the collected information to the traffic management server, and
the traffic management server calculates, based on quality information of the terminal devices, a quality of experience (QoE) index of each application used by the terminal devices, and calculates and displays a service area of the application in each base station and each application based on the information of the service area, the number of terminal devices quality of experience (QoE) indexes of which exceed a predetermined value, and the number of terminal devices using the application.

6. The network system according to claim 5, wherein the traffic management server plots, on one graph, a service area of each of a plurality of applications in each base station and performs at least one of control of the base station and traffic control of the specific terminal device based on a region in the plotted graph and application distribution in the base station.

7. A traffic management server in a network system including a plurality of terminal devices, a plurality of base stations configured to house the plurality of terminal devices, a base station management server configured to manage the plurality of base stations, a core network-side device connected to the plurality of base stations, an analysis device configured to acquire a packet between the plurality of base stations and the core network-side device, and the traffic management server connected to the analysis device,
wherein the traffic management server is connected to the base station management server configured to control the base stations,
acquires, based on the packet, information of an application used by the terminal devices, and
gives, based on the information of the application, at least one of an instruction to the base station management server to perform control of the base stations and an instruction to the core network-side device to perform traffic control of a specific terminal device.

8. The traffic management server according to claim 7, wherein the traffic management server
specifies, based on the packet, a type of an application used by the terminal devices,
counts the kind of the application in each base station and calculates application distribution in the base station, and
gives an instruction, based on the application distribution, to the base station management server to perform control of the base station.

9. The traffic management server according to claim 7, wherein the traffic management server
receives information of a specific base station from the base station management server which detects an alarm in the specific base station,
calculates application distribution in the specific base station based on a type of an application used by a terminal device connected to the specific base station, and
gives an instruction, based on the application distribution, to the core network-side device to perform traffic control of a terminal device using a specific application.

10. The traffic management server according to claim 7, wherein the traffic management server
specifies a base station with deteriorated quality,
calculates application distribution in the specified base station based on a type of an application used by a terminal device connected to the specified base station, and
gives, based on the application distribution, an instruction to the base station management server to perform control of the specified base station and an instruction to the core network-side device to perform traffic control of a terminal device using a specific application.

11. The traffic management server according to claim 7, wherein the traffic management server
receives information of a service area of each of the base station from the base station management server,
calculates, based on quality information of the terminal devices, a quality of experience (QoE) index of each application used by the terminal devices, and
calculates and displays a service area of the application in each base station and each application based on the information of the service area, the number of terminal devices quality of experience (QoE) indexes of which exceed a predetermined value, and the number of terminal devices using the application.

12. The traffic management server according to claim 11, wherein the traffic management server
plots, on one graph, a service area of each of a plurality of applications in each base station, and
gives, based on a region in the plotted graph and application distribution in the base station, at least one of an instruction to the base station management server to perform control of the base station and an instruction to the core network-side device to perform traffic control of a specific terminal device.

13. A network system comprising:
a plurality of terminal devices;
a plurality of base stations configured to house the plurality of terminal devices;
a base station management server configured to manage the plurality of base stations;
a core network-side device connected to the plurality of base stations;
an analysis device configured to acquire a packet between the plurality of base stations and the core network-side device; and
a traffic management server connected to the analysis device,
wherein the base station management server collects information of a service area of each of the base stations and transmits the collected information to the traffic management server, and
the traffic management server acquires, based on the packet, information of an application used by the terminal devices and quality information of the terminal devices, calculates a quality of experience (QoE) index of each application used by the terminal devices based on the quality information of the terminal devices, and calculates and displays a service area of the application in each base station and each application based on the information of the service area, the number of terminal devices quality of experience (QoE) indexes of which exceed a predetermined value, and the number of terminal devices using the application.

14. The network system according to claim 13, wherein
the traffic management server plots, on one graph, a service area of each of a plurality of applications in each base station, and
the traffic management server gives, based on a region in the plotted graph and application distribution in the base station, at least one of an instruction to the base station management server to perform control of the base station and an instruction to the core network-side device to perform traffic control of a specific terminal device.
